(19) United States
(12) Patent Application Publication
(10) Pub. No.: US 2008/0297480 A1
(43) Pub. Date: Dec. 4, 2008

(54) Method of Inputting Multi-Languages by Using Symbol Characters Allocated in Keypads of User Terminal

(76) Inventor: Byung-Hwan Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/089,014

(22) PCT Filed: Oct. 9, 2006
(86) PCT No.: PCT/KR06/04050

§ 371 Date: Apr. 2, 2008

(30) Foreign Application Priority Data
Oct. 5, 2005 (KR) 10-2005-0093451

(51) Int. Cl. G06F 3/02

(52) U.S. Cl. 345/169

(57) ABSTRACT

A method of inputting multi-language characters using symbol characters, which can quickly input a character with a small number of inputs by converting a word unit character input system into a combination type character input system, and adopting a character input method using a combined symbol based on a stroke of each unique character, and also can reduce a mistype probability, which may occur due to a continuous push, and thereby precisely input a desired character is provided.

### TECHNICAL FIELD

The present invention relates to a method and system for inputting characters of every language more simply, quickly, and precisely by suggesting a method of inputting a combined symbol character per a symbol unit, not a word unit, using symbol characters, in which the symbol characters are selected based on a stroke of characters of every language.

### BACKGROUND ART

As portable devices become highly efficient and convergent, and also have a mass capacity, all terminals for connecting a network are attaining a performance similar to a personal computer (PC). Accordingly, a keypad character input function becomes an important issue. The keypad character input function is generally utilized for a mobile phone, an integrated wired/wireless terminal, an Internet Protocol (IP) telephone, a bi-directional television remote control, a game device, home electronics, and the like.

A portable device generally includes a character input unit for inputting characters, which are required for text messages, mails, chatting, web information searches, Uniform Resource Locator (URL) inputs, character telephone services, and the like. Particularly, the bi-directional television remote control requires a character input unit for inputting characters, which are required for return messages, broadcast data, web addresses, program searches, multi-media data searches, and other home services.

Existing character input units adopt a method of inputting any language based on a keypad with 12 key buttons. Also, character input methods, which are utilized by the character input units, include a multi-tap input method, a word database-based single tap (button combination) input method, and the like.

In the case of the multi-tap input method, 3 to 4 consonants/vowels are allocated to each button. As an example, each of ABC, DEF, . . . , PQRS, TUV, and WXYZ is allocated to a single respective (*“corresponding”?*) button. Also, the multi-tap input method inputs a corresponding consonant or vowel by pushing a corresponding button at least once in an order of consonants/vowels, which are displayed on the button, to display at least two consonants/vowels allocated to the single button. As described above, in the multi-tap input method, a user is required to press a button a number of times. When the user consecutively inputs key buttons, a mistype may occur due to a time delay. Accordingly, when consecutively inputting consonants/vowels which are allocated to the same key button, the user may input a next consonant/vowel by making a cursor move to a next input standby state via a navigation key, or after a predetermined period of time elapses.

Also, the single tap input method is conceived to solve the above-described disadvantages of the multi-tap input method, and generally utilizes a single tap prediction input method (an input method of Tegic Communication Inc. and Zi Technology Corporation LTD.) which utilizes an existing keypad keyboard (ABC, DEF, . . . , PQRS, TUV, WXYZ). In this instance, the single tap input method utilizes a word database which is constructed based on frequencies of words that are used for daily conversations. When a word is inputted by pushing a key button only once, irrespective of an order of each consonant/vowel allocated to each key button, using a standard keyboard as used in the multi-tap method, combinable words are displayed on a display in interoperation with the word database. In this case, the user manipulates a navigation button and selects a desired word from the displayed combinable words. As an example, when the user desires to input ‘Hi’, and in this instance, the user pushes a key button allocated with ‘H’ and a key button allocated with ‘i’, candidates for combinable words, including Hi, are displayed on the display. Thus, the user may select and input ‘Hi’ by using a navigation button, and the like.

However, the word database-based single tap input method must go through a process of selecting a word from candidate words and confirming the selected word. Thus, the user is required to check a screen and a keypad in turn. Also, the user takes inconvenience to press the navigation button and the keypad in turn. Also, with respect to words, which are not stored in the word database, such as URLs, proper nouns, addresses, email addresses, abbreviations, new words, various place names, person names, broadcast programs, slang, foreign languages, technical terminologies, and the like, a character input mode must be converted into the above-described multi-tap input method.

With respect to various languages, such as English, a Japanese language, a Russian language, an Arabic language, a Hebrew language, a Hindi language, and the like, excluding a Korean language, a character input system of a computer input system utilizes a method of arranging characters for each word. Thus, there is no alternative method, excluding the multi-tap input method and the single tap input method as described above. Currently, many languages utilize a number of characters. As an example, languages, such as a French language, an Italian language, a Spanish language, a Portuguese language, a Swahili language, and the like, utilize 30 to 40 Roman alphabetical characters. Languages, such as a Russian language, a Mongolian language, and the like, utilize 33 to 60 Cyrillic characters, which are used in eastern European countries or central Asian countries, and the like. A Persian language utilizes 28 to 40 Arabic characters. In addition to the above-described languages, a Turkish language, a Kurdish language, a Greek language, a Hebrew language, which cannot input a vowel, and the like, utilize a great number of characters. Thus, 3 to 5 characters are allocated to each key button. Consequently, when utilizing the conventional multi-tap input method and the single tap input method, a mistype rate and a number of combinable characters may also increase. In other words, the multi-tap input method and the single tap input method may not be readily utilized.

Currently, 20 or more syllabic character languages which utilize 50 to 251 characters, such as Indian-derived languages, a Bengali language, a Burmese language, a Thai language, a Cambodian language, an Ethiopia language, and the like, have no keypad input method. Also, since 5 to 9 characters are allocated to a single key button, characters of a corresponding language may not be readily inputted. Tegic Communication Inc. and Zi Technology Corporation LTD. developed a method of inputting Devanagari characters and Bengali characters. However, the above-described problems still remain.

Also, in the case of a Japanese language, a 50 sound allocation type (multi-tap input method) utilizes a method of allocating 5 characters to a single key button and thereby inputting a character corresponding to a key-stroked number. Also, a single tap input method is additionally utilized to solve a usage problem which may occur since a plurality of characters is allocated to single key button. The single tap input method is utilized for an English and Japanese input method of Tegic Communication Inc., and a number guidance service of the Japanese company, NTT. Also, the single tap input method utilizes an input keyboard which is identical to the multi-tap input method. Also, candidate words are displayed in an order of usage frequencies by reflecting properties of Japanese and also including combinable words and clauses attached with an auxiliary word. Specifically, general sentences may be quickly inputted with a comparatively small number of input strokes.

However, as described above, since the single tap input method corresponds to a combined button input method, a selection and determination process must be used for each word. Also, when a great number of combinable candidate words is displayed, a user is required to directly determine whether to search the candidate words for a desired word via a navigation key or whether to input an additional character and thereby reduce the candidate words. In this instance, the additional character must be stored in the word database.

Also, the Japanese input method includes a multi-tap prediction input method. The multi-tap prediction input method is developed by POBox of Sony Corporation. In the multi-tap prediction input method, when a single word is inputted, associated words, auxiliary words, conjunctions, and the like, are sequentially display on a screen. In this instance, a user may select a desired word from the displayed candidate words. However, the multi-tap prediction input method may not include all sentences, which is the same as in the conventional art. Also, since too many candidate words may be displayed, a particular word may not be effectively selected and inputted. Also, a consonant/vowel separation type cut key input method, which combines and inputs consonants and vowels of HIRAGANA, is utilized. In the method, a plurality of characters is allocated to each of 12 key buttons. Thus, the above-described problems of the multi-tap character input method may still remain with respect to some characters.

While young Japanese may think that the above-described single tap input method is easy and convenient, most Japanese utilize the multi-tap input method, which may become an issue since most countries utilize the single tap input method.

Also, when inputting Chinese characters, such as a Chinese language, and the like, the multi-tap input method, the single tap input method, and a stroke number input method are being utilized. In the case of Chinese characters, a great number of characters exist, and also a shape of some Chinese characters is very complex. Thus, a PINYIN input method, which inputs a Chinese character using a PINYIN system, is generally utilized. However, since the PINYIN input method basically utilizes Roman alphabetical characters, the above-described problems of the multi-tap input method and the single tap input method still exist. Particularly, in the case of a Roman alphabetical character-based single tap input method, a plurality of candidate PINYIN is displayed according to a phoneme inputted by a user. Also, a plurality of homonymic Chinese characters corresponding to each candidate PINYIN is displayed. Thus, process of combination variables becomes very complex.

To solve the above-described problems when inputting Chinese characters, Korean AMASASOFT utilizes a Roman alphabetical character-based standard keyboard, which is the same as the multi-tap input method and the single tap input method. To input three to four Roman alphabetical characters (ABC, DEF, . . . , PQRS, TUV, WXYZ), which are allocated to each key button, a syllable unit input method is utilized. Specifically, when a user pushes a ‘*’ key button of a keypad and then pushes a key button corresponding to a first Roman alphabetical character, the first Roman alphabetical character is inputted. Also, when the user pushes a key button corresponding to a second Roman alphabetical character, the second Roman alphabetical character is inputted. Also, when the user pushes a ‘#’ key button and then pushes a key button corresponding to a third Roman alphabetical character, the third Roman alphabetical character is inputted. Also, when the user pushes a ‘0’ key button and then pushes a key button corresponding to a fourth Roman alphabetical character, the fourth Roman alphabetical character is inputted. Only candidate Chinese characters corresponding to PINYIN may be displayed by using the Roman alphabetical character-based input method. However, a fundamental problem still remains. Specifically, a Roman alphabetical character input itself is complex. A reduced SHENGMU input function can display combinable candidate Chinese characters and input a word unit when only PINYIN corresponding to SHENGMU of a Chinese character is inputted. However, even in this method, the above-described problems of the Roman alphabetical character input method still remain. Also, there is a method of selecting a Chinese character via a navigation key and inputting the selected Chinese character when candidate Chinese characters are displayed on a screen according to an input stroke number by allocating a basic stroke number, which constitutes a Chinese character, and combining the stroke number. Representative examples include six stroke number of Tegic Communication Inc. and eight stroke number of Zi Technology Corporation LTD. However, a great number of candidate Chinese characters are provided for an initial stroke number input. Also, a user may not recognize a representative stroke number allocated to a key button as a various types of stroke numbers are utilized. Thus, the above-described methods are not widely utilized.

In the case of a HANGUL character input method, a CHUNJIIN method and a NARAGUL method are representatively utilized. However, the CHUNJIIN method requires a frequent input of vowels. Also, in the case of a multi-tap input with respect to consonants, a single consonant may be consecutively inputted for a final consonant and an initial consonant of a character. Also, when two consonants allocated to a single key button are consecutively inputted for an initial consonant and a final consonant, a mistype may frequently occur. In the case of the NARAGUL method, a number of input strokes is reduced with fewer mistypes. However, since an added stroke for both consonants and vowels, and a complex rule of double consonants are applied, an input rule becomes more complex. In addition, in association with input of HANGUL characters, various types of input methods are suggested according to an arrangement and combination method of consonants and vowels by using a multi-tap input method. Also, considering characteristics of a combination type character system of HANGUL characters, various types of HANGUL character input methods are provided according to an arrangement and combination method of consonants and vowels. As an example, a sky HANGUL character input method is being utilized. Also, various types of HANGUL character input methods, such as HANGULI, HANGUL TONGIL, simple wording, a HOONMIN keyboard, a HANGUL code, a quick key, and the like, are utilized. The various types of HANGUL character input methods, as described above, are mainly focused on how to reduce a number of strokes and thereby improve an input speed. However, although the above-described methods may reduce the number of strokes by a single stroke or two strokes in comparison to the CHUNJIIN method or the NARAGUL method, phonemes which are allocated on a single key button may not be readily recognized. Also, the input speed may be deteriorated in comparison to the CHUNJIIN method or the NARAGUL method.

Representative examples of a keypad input method of all characters include multi-tap and single tap input method prototypes. Also, various types of methods, such as a mark combination type input method, 12 key buttons+modulated keyboard, keypad graffiti—JASOMOSA type (easy writing), navigation key graffiti—JASOMOSA type (CLURD input method), rotary key graffiti type—JASOPILGI type (MyText) and specific keys—graffiti—JASOMOSA type (Thumscript) input method, were developed. However, the above-described methods do not consider a user's natural recognition and behavior pattern. Also, the above-described methods are comparatively more related to hardware and a character system than user convenience. Also, since only a reduction of a number of strokes is considered, an input rule is very complex. Specifically, due to a usage problem, many of the above-described methods have not been commercialized. The mark combination type input method of Neopad Co., Ltd. utilizes 10 combined marks which are generated by simplifying strokes of all characters. Specifically, the mark combination type input method employs a syllable unit method which inputs a character based on a combined mark database for each word. However, due to extremely simplified marks, a user may not easily recognize a character. Also, like the single tap input method, the user is required to push a keypad and a navigation key in turn for each word. Thus, the above-described method is not commercialized.

### BRIEF DESCRIPTION OF DRAWINGS

FIG. 1 is a diagram illustrating a multi-language character input system using a symbol character according to the present invention;

FIG. 2 is a block diagram illustrating a configuration of a character input device according to an embodiment of the present invention;

FIG. 3 is a diagram illustrating an example of a symbol character corresponding to a key button which is stored in a table according to the present invention;

FIG. 4 is a diagram illustrating a structure of a terminal keypad, which is utilized for a Roman alphabetical character input method, and a method of inputting a combined symbol character according to a key button input signal, which is included in the terminal keypad, according to the present invention;

FIG. 5 is a diagram illustrating a structure of a terminal keypad, which is utilized for a Arabic character input method, and a method of inputting a combined symbol character according to a key button input signal, which is included in the terminal keypad, according to the present invention;

FIG. 6 is a diagram illustrating a structure of a terminal keypad, which is utilized for a Hebrew character input method, and a method of inputting a combined symbol character according to a key button input signal, which is included in the terminal according to the present invention;

FIG. 7 is a diagram illustrating a structure of a terminal keypad, which is utilized for a Cyrillic character input method, and a method of inputting a combined symbol character according to a key button input signal, which is included in the terminal according to the present invention;

FIG. 8 is a diagram illustrating a structure of a terminal keypad, which is utilized for a Greek character input method, and a method of inputting a combined symbol character according to a key button input signal, which is included in the terminal according to the present invention;

FIG. 9 is a diagram illustrating a structure of a terminal keypad, which is utilized for a Chinese character input method, and a method of inputting a combined symbol character according to a key button input signal, which is included in the terminal according to the present invention;

FIG. 10 is a diagram illustrating an example of a combined stroke input method and a PINYIN input method via the terminal keypad illustrated in FIG. 9;

FIG. 11 is a diagram illustrating a structure of a terminal keypad, which is utilized for a HANGUL character input method, and a method of inputting a combined symbol character according to a key button input signal, which is included in the terminal according to the present invention;

FIG. 12 is a diagram illustrating a structure of a terminal keypad, which is utilized for a Thai character input method, and a method of inputting a combined symbol character according to a key button input signal, which is included in the terminal according to the present invention; and

FIG. 13 is a diagram illustrating a combined Thai character code which is utilized for a method of inputting Thai characters according to the present invention.

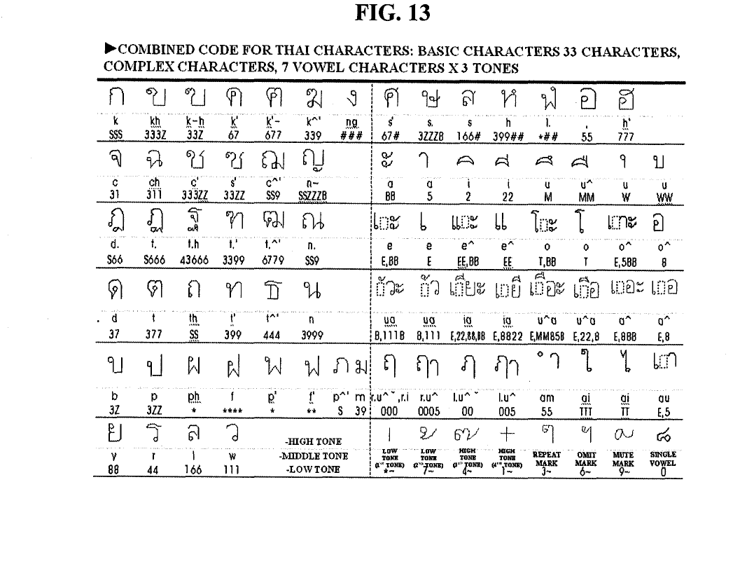

### DISCLOSURE OF INVENTION

### Technical Goals

The present invention provides a method of inputting multi-language characters using symbol characters, which can quickly input a character with a small number of inputs by converting a word unit character input system into a combination type character input system, and adopting a character input method using a combined symbol based on a stroke of each unique character, and also can reduce a mistype probability, which may occur due to a continuous push, and thereby precisely input a desired character.

The present invention also provides a method of inputting multi-language characters using symbol characters, which enables a user to easily recognize a symbol character since the symbol character is allocated based on 1:1 or 1:2 allocation with respect to symbol:button, a comparatively big symbol, and a symbol shape, and thus, enables the user to enter the symbol character according to a stroke order based on a character composition principle, and also enables the user to easily learn an input rule when entering a character on a terminal.

The present invention also provides a method of inputting multi-language characters using predictable symbol characters, which can predictably arrange symbols and input keys corresponding to a writing stroke order of a character of a corresponding language.

The present invention also provides a method of inputting multi-language characters which can provide the same input method when inputting a user's mother language characters and Roman alphabetical characters, to correspond to a convergent next generation terminal and service for all languages, and also can utilize a composite combined symbol when inputting the user's mother language characters and Roman alphabetical characters, so that a consistent Roman alphabetical character input method may be applied to a character input method of each language.

The present invention also provides a method of inputting multi-language characters, which can utilize all character input systems based on a keypad system. Here, the keypad system overcomes the limit with respect to a keypad size and button arrangement of a small handset terminal.

### Technical Solutions

According to an aspect of the present invention, there is provided a method of inputting Roman alphabetical characters via at least one key button of a terminal, the method including: maintaining a keypad which includes the at least one key button disposed with at least one of symbol characters according to each shape of the Roman alphabetical characters, [symbol] [symbol] and [symbol] maintaining a table which stores a combined symbol character corresponding to an input signal of the key button; receiving the input signal of the key button from a user; extracting the combined symbol character corresponding to the input signal of the key button by referring to the table; and outputting the extracted combined symbol character to a predetermined display.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

The term “symbol character” used throughout the present specification may designate a character which is symbolized by analyzing an external shape of the character and thereby extracting a basic stroke, which is required to express a particular character. Specifically, the symbol character corresponds to a shape of a stroke, which is commonly used for characters of a single language, or a shape of a unique stroke which is utilized for a particular character. Thus, when disassembling any character of a particular language, the character may be disassembled into at least one symbol character which is selected in the language. Conversely, the character may be completed by using the symbol character.

As an example, the symbol character may be symbolized by disassembling and reinterpreting an existing character, such as a single phoneme, a division of the phoneme, a combination of strokes, a combination of phonemes, and the like. When completely transcribing and inputting 26 Roman alphabetical characters without a mistype, symbol characters of [symbol] [symbol] and [symbol] may be required.

The symbol characters may be arranged in association with key buttons of a terminal which has a character input function. When a terminal user pushes a single key button or a plurality of key buttons, associated symbol characters may be extracted. Here, the extracted symbol characters may be combined with each other in a character input system of the present invention, and then generated into a single character (combined symbol character). As an example, symbol characters [symbol] and [symbol] may be generated into a combined symbol character [symbol] via a combination process, which has the meaning of a Roman alphabetical character ‘A’.

As described above, according to the character input method using a symbol character, characters of each language may be easily inputted according to a simple input method of selecting each unique character type symbol and thereby inputting a character in a writing order, by converting existing character input systems with respect to Roman alphabetical characters, Arabic characters, Hebrew character, Cyrillic character, and the like, into a combination type character input system.

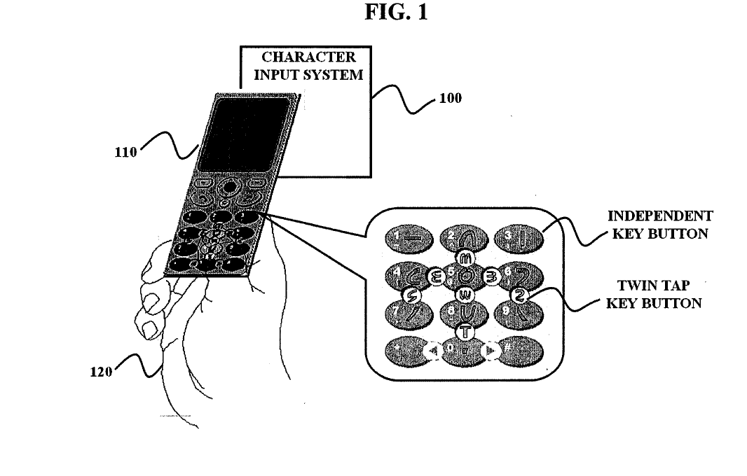

FIG. 1 is a diagram illustrating a multi-language character input system using a symbol character according to the present invention.

A character input system 100 functions to combine symbol characters which are extracted according to a key button input signal received from a terminal 110 having a character input function, and to extract the combined symbol character. Also, in the case of Arabic characters, and Hebrew characters, the character input system 100 functions to extract a symbol character, and thereby convert the extracted symbol character into an independent type, a head word type, a middle word type, and a tail word type according to a character location. Specifically, the character input system 100 registers a symbol character to be set by considering a stroke of a character, and searches a symbol character associated with a key button when a terminal user 120 pushes the key button. Also, the character input system 100 may generate a combined symbol character using at least one retrieved symbol character according to a predetermined character composition principle. As described above, the character input system 100 may display a shape where the generated combined symbol character is designed into a printed character or a symbol character, on the terminal 110.

The character input system 100 may be located inside or outside of the terminal 110 and flexibly support a character input service. In the present specification, the character input system 100 is installed in the terminal 110, which is for convenience of description.

The terminal 110 functions to generate a key button input signal in interoperation with the terminal user's 120 stroke (pushing operation) on a key button, and transmit the generated key button input signal to the character input system 100 of the present invention. Thus, the terminal 110 may include a key button for selecting a predetermined symbol character according to the present invention, a display for displaying a character of a multi-language (symbol character shape, printing type shape), which is determined in the character input system 100, and the like.

Particularly, the key button of the terminal 110 may include independent key buttons for generating various types of function signals via a pushing operation, and twin-tap key buttons for simultaneously inputting the function signals via a single pushing operation with respect to a plurality of independent key buttons. Each of the independent key buttons and the twin-tap key buttons is associated with a single symbol character or a plurality of symbol characters. Thus, when the terminal user 120 inputs a particular key button, a key button input signal of an associated symbol character may be generated and transmitted to the character input system 100. Specifically, the character input system 100 may arrange the independent key buttons and the twin-tap key buttons on the terminal 110 in a form of a 7×5 matrix, by considering a convenience of the terminal user 120.

Also, when a character display signal is transmitted from the character input system 100 in response to the key button input signal, the terminal 110 may display a symbol character shape or a printing type shape corresponding to the key button input signal on a display or may output the symbol character shape or the printing type shape to an externally located remote device.

A symbol character associated with a key button of the terminal 110 may be arbitrarily designed and arranged by a system operator.

The terminal 110 may transmit the displayed character to another terminal, which is located in a remote location, via a predetermined communication module and thereby enable a communication service, such as text message communication, text message recording, and the like.

The terminal 110 has functions of inputting a character using a symbol character, displaying a character, transmitting a displayed character to another terminal, and the like. In this instance, due to a device size, a number of key buttons must be limited. Examples of the terminal 110 may include a wired/wireless telephone, a personal digital assistant (PDA), a control console for a video game, and all devices that require a keypad character input, such as a television remote control, a wearable personal computer (PC), a bi-directional Digital Multimedia Broadcasting (DMB), a telematics device, a tablet PC, a handset keypad character input device, and the like.

The character input system 100 inputs characters based on a symbol for each of the characters and a combination of symbols, using a person's positive image association capacity which can recognize (read) a different calligraphic style as a common linguistic mark. Specifically, the terminal user 120 may push a key button of the terminal 110 by considering a character which is associated from a symbol character itself or a combination of a plurality of symbol characters. The character input system 100 combines symbol characters corresponding to key button input signals from a predetermined table and thereby display a completed character, i.e. a combined symbol character, on the terminal 110. In this instance, each of the key button input signals is generated by pushing a corresponding key button according to a combination of key buttons. As described above, the combined symbol character, which is extracted from the table according to a user's input on the key buttons, may be outputted to a remote device.

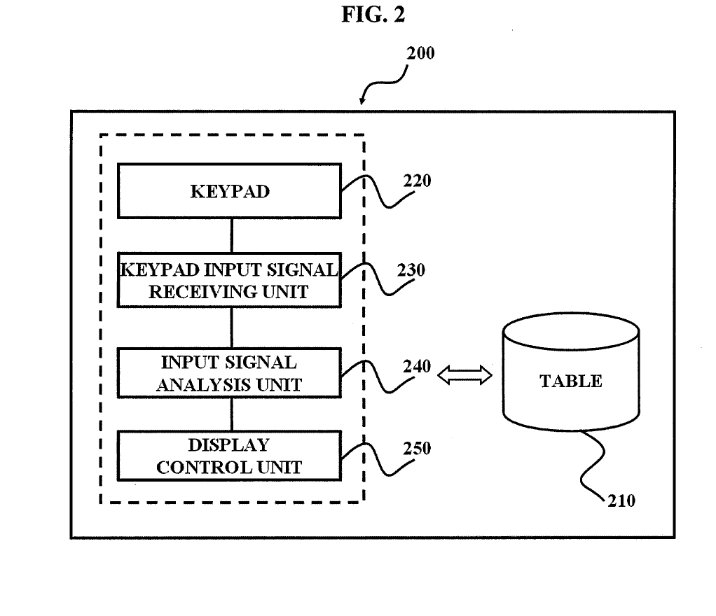

Hereinafter, a character input device 200 according to the present invention will be described in detail with reference to FIG. 2.

FIG. 2 is a block diagram illustrating a configuration of a character input device according to an embodiment of the present invention.

The character input device 200 may include a table 210, a keypad 220, a keypad input signal receiving unit 230, an input signal analysis unit 240, and a display control unit 250.

The table 210 stores a symbol character corresponding to a key button input signal. Specifically, the table 210 associates a keypad input signal with respect to a single symbol or a plurality of symbols and a combined symbol character of each character with respect to each key button (independent key button and twin-tap key button) of the terminal 110, and thereby stores the symbol(s). According to a combination of key buttons pushed by the terminal user 120, i.e. according to key button input signals, symbol characters may be combined into a combined symbol character and the combined symbol character may be extracted.

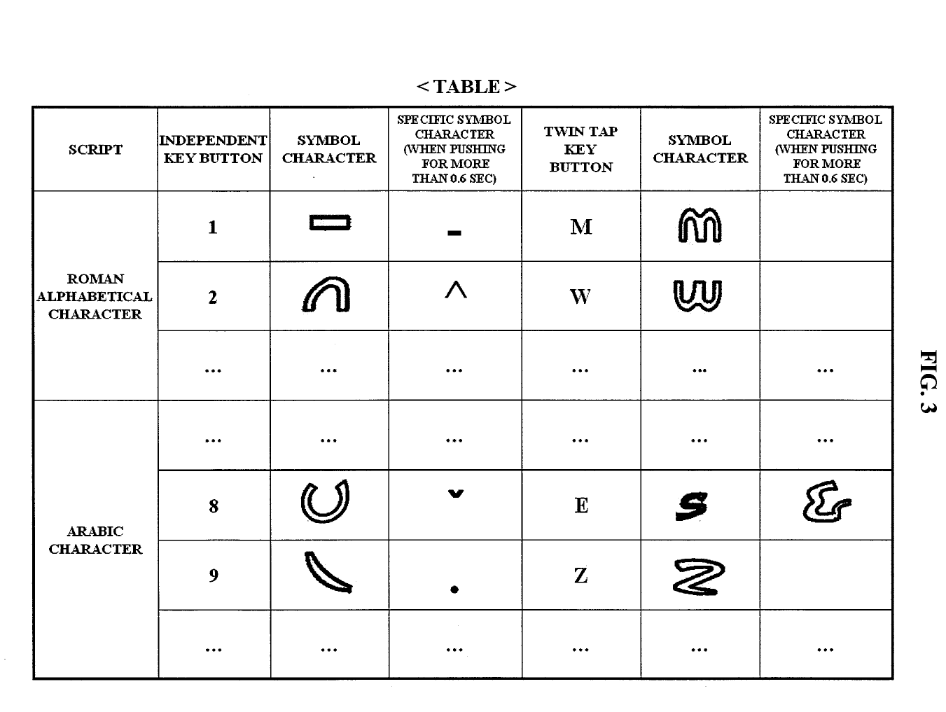

Hereinafter, the table 210 for storing a symbol character will be described in detail with reference to FIG. 3.

FIG. 3 is a diagram illustrating an example of a symbol character corresponding to a key button which is stored in a table according to the present invention.

The table 210 stores a symbol character corresponding to each key button of the terminal 110 for each language according to a character type. Also, the table 210 stores and maintains a symbol character corresponding to each key button of the terminal 110 according to character information.

The character type may be generated by considering languages (language groups), such as Roman alphabetical characters and Arabic characters illustrated in FIG. 3, and Hebrew characters, Cyrillic characters, Greek characters, Chinese characters, Hangul characters, Thai characters, and the like, which are supported by a character input method of the present invention.

As an example, in the case of the character type corresponding to Roman alphabetical characters, the table 210 allocates symbol characters [symbol] and [symbol] to independent key buttons ‘1 and 2’ respectively, and allocates symbol characters [symbol] and [symbol] to twin-tap key buttons ‘M and W’ respectively. Specifically, when the terminal user 120 utilizes Roman alphabetical characters as a usage language group, and pushes the independent key button 1 of the terminal 110, the character input system 200 of the present invention may identify the symbol character [symbol] which is allocated to the independent key button 1, by referring to the table 210. Also, when the terminal user 120 pushes the twin-tap key button M, the character input system 200 may identify the symbol character [symbol] corresponding to the twin-tap key button M, by referring to the table 210. In this instance, a pushing operation with respect to the twin-tap key button M may designate a pushing operation of receiving a key button pushing signal (inputting signal) with respect to ‘5’ (or ‘2’) within a predetermined period of time, while receiving a key button pushing signal (inputted signal) with respect to ‘2’ (or ‘5’), in association with independent key buttons ‘2 and 5’. Specifically, the pushing operation may designate a kind of simultaneous pushing operation. Thus, the table 210 may be maintained so that the symbol character [symbol] may correspond to the independent key buttons ‘2 and 5’, in addition to the twin-tap key button M.

Also, the table 210 may store and maintain a special symbol character, which corresponds to the key button input signal, and also includes information about a time length of the key button input signal. Thus, when a duplicate allocation is required due to a great number of consonants and vowels, such as Arabic characters, the present embodiment may be very usefully utilized. Here, information about the time length of the key button input signal designates information about a period of time when the key button input signal is continuous. Specifically, information of the time length designates information about a period of time when the terminal user 120 keeps pushing a particular key button. In FIG. 3, as an example, information about the time length is ‘more than 0.6 second’.

As an example, when the terminal user 120 utilizes Roman alphabetical characters for a usage language group, and keeps pushing the independent key button ‘2’ for more than 0.6 seconds, the character input system 200 may input a special symbol character ‘̂’ by referring to the table 210. In this case, when the terminal user 120 pushes the independent key button ‘2’ for less than 0.6 seconds, the character input system 200 extracts the basic symbol character [symbol] .

As described above, the character input system 200 according to the present invention may support an input service of a basic symbol character and also support an additional input service with respect to a special symbol character when continuously pushing a key button for more than a predetermined period of time.

Also, the table 210 may further store and maintain diacritics which are allocated to some of the independent key buttons or the twin-tap key buttons. In this instance, the diacritics may designate marks which are defined for each, language (e.g., Umlaut, Tilde, etc.). As an example, the table 210 may additionally include diacritics used for a Spanish language, and diacritics used for a French language, in a key pad corresponding to each language. Specifically, the table 210 provides an environment where diacritics are stored for each language and thus, the terminal user 120 may input Roman alphabetical characters attached with the diacritics.

The keypad input signal receiving unit 230 functions to receive a key button input signal from the keypad 220. The received key button input signal is transmitted from the keypad input signal receiving unit 230 to the input signal analysis unit 240. The input signal analysis unit 240 extracts a combined symbol character corresponding to the key button input signal by referring to the table 210. Also, the extracted combined symbol character may be outputted to a predetermined display or outputted to a remote device (not shown) which connects with wired/wireless media, via the display control unit 250.

In the present invention, examples of a character composition principle using the table 210 and the input signal analysis unit 240 may include a Roman alphabetical character composition principle, an Arabic character composition principle, a Hebrew character composition principle, a Cyrillic character composition principle, a Greek character composition principle, a Thai character composition principle, a Chinese character composition principle, a Hangul character composition principle, and the like. The character composition principle may be selectively employed by considering the terminal user's 120 language.

As an example, when key button input signals associated with key buttons ‘1’ and ‘2’ are received from the terminal user 120, which belongs to a group of languages using Roman alphabetical characters, and thereby the symbol character extraction unit 220 extracts symbol characters [symbol] and [symbol] the symbol character combination unit 230 may combine the symbol characters [symbol] and [symbol] in a combined symbol character [symbol] according to the Roman alphabetical character composition principle. In this instance, a plurality of unspecific persons may associate the combined symbol character [symbol] with a Roman alphabetical character ‘A’.

The display control unit 250 functions to control a generated combined symbol character to be displayed on a predetermined display. Here, the display may be included in the terminal 110. Also, the display provides information about an input status of a symbol character or an output status of a combined symbol character to the terminal user 120 via a predetermined interface.

In the present embodiment, it has been described that symbol characters of each language are stored in the table 210 and a symbol character corresponding to a key button input signal is extracted. Also, in the case of languages, such as a Chinese language, a Japanese language, and the like, which input characters of each corresponding language using a Roman alphabetical character notation system, when a Roman alphabetical character is inputted according to the Roman alphabetical character notation system, a corresponding character may be extracted or inputted.

Here, the character input system 200 may further include a second memory (not shown). The second memory stores Roman alphabetical characters and a character of each language corresponding thereto.

Also, in the present embodiment, it has been described that associated symbol characters are extracted according to a stroke of a character, and a combined symbol character generated by using the extracted symbol characters is provided to the display of the terminal 110. However, it is only an example and thus, the present invention is not limited thereto. Also, a symbol character shape or a printing type shape, which a general user is familiar with, may be provided to the display.

According to another embodiment of the present invention, the character input system 200 may further include a second table (not illustrated) to achieve the above-described objective. Here, the second table stores printing type characters for each language, and the input signal analysis unit 240 retrieves a generated symbol character shape or a printing type shape. Specifically, the terminal 110 may store the printing type shape or the symbol character shape in the second table. Thus, according to the present invention, it is possible to revise a conventional character input method which requires a user to repeatedly push a single key button to input a particular character by allocating a plurality of characters to a single key button. Also, according to the present invention, it is possible to reduce a number of pushing operations by adopting a combined input method, which is based on a combination of symbol character. Thus, a character input time may be significantly reduced. Also, the present invention inputs a symbol character according to a stroke order based on a character composition principle, and thus, when inputting a character on a terminal, the present invention may provide a comparatively simple input method.

When expressing another language in addition to Roman alphabetical characters, the present embodiment displays the other language on a display by using a symbol, which is generated by combining a Roman alphabetical character and each unique character. However, it is only an example and thus, the present invention is not limited thereto. Specifically, according to the present invention, it is possible to express various types of languages by allocating symbol characters of each language to key buttons (including seven twin-tap key buttons) which are arranged in a form of a 7×5 matrix or a 5×7 matrix.

Hereinafter, a method of inputting characters of each language using the character input system 200 according to the present invention will be described in detail.

Roman Alphabetical Character Input

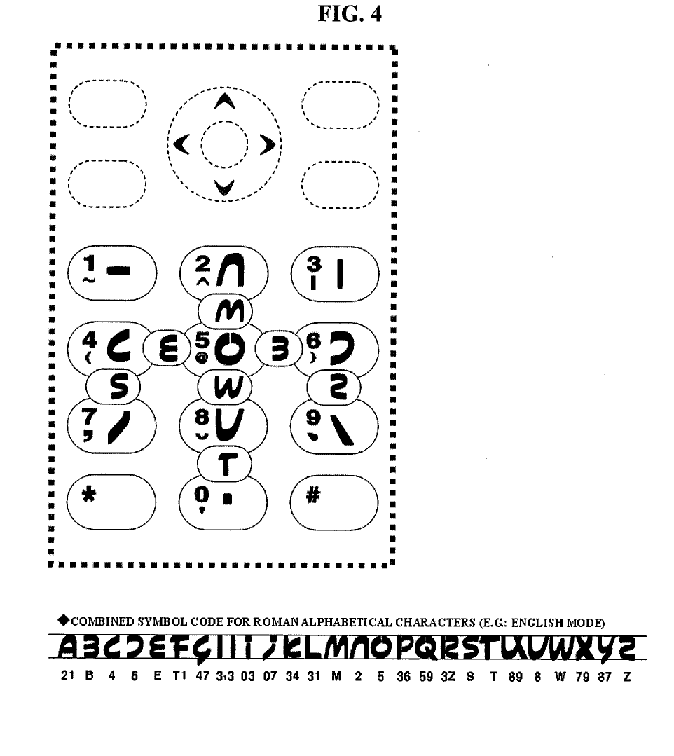

FIG. 4 is a diagram illustrating a structure of a terminal keypad, which is utilized for a Roman alphabetical character input method, and a method of inputting a combined symbol character according to a key button input signal, which is included in the terminal keypad, according to the present invention.

Roman alphabetical characters, generally referred to as the alphabet, consist of 26 characters. To input the Roman alphabetical characters, an operator of the present system selects symbol characters, [symbol] [symbol] and [symbol] Also, the operator associates each of the symbol characters with each corresponding key button of the terminal 110, based on a usage frequency, character input convenience for the terminal user 120, and the like.

As an example, referring to FIG. 4, each of the symbol characters, [symbol] [symbol] and [symbol] is associated with each of independent key buttons, 1, 2, 3, 4, 5, 6, 7, 8, 9, and 0. Also, each of the symbol characters, [symbol] and [symbol] is associated with each of twin-tap key buttons ‘W, M, E, B, S, T, and Z’. Specifically, the symbol character [symbol] may correspond to the independent key button ‘0’, the symbol character [symbol] to the independent key button 1, the symbol character [symbol] to the independent key button 2, the symbol character [symbol] to the independent key button 3, the symbol character [symbol] to the independent key button 4, the symbol character [symbol] to the independent key button 5, [symbol] to the independent key button 6, the symbol character [symbol] to the independent key button 7, the symbol character [symbol] to the independent key button 8, and the symbol character [symbol] to the independent key button 9 respectively. Also, the symbol character [symbol] may be allocated to a twin-tap key button for simultaneously inputting the key buttons 5 and 8, the symbol character [symbol] to a twin-tap key button for simultaneously inputting the key buttons 2 and 5, the symbol character [symbol] to a twin-tap key button for simultaneously inputting the key buttons 4 and 5, the symbol character [symbol] to a twin-tap key button for simultaneously inputting the key buttons 5 and 6, the symbol character [symbol] to a twin-tap key button for simultaneously inputting the key buttons 4 and 7, the symbol character [symbol] to a twin-tap key button for simultaneously inputting the key buttons 8 and 0, and the symbol character [symbol] to a twin-tap key button for simultaneously inputting the key buttons 6 and 9.

In this instance, when the terminal user 120 arbitrarily pushes key buttons, the character input system 200 may extract a symbol character associated with each of the pushed key buttons, and combine extracted symbol characters into a combined symbol character to correspond to a corresponding Roman alphabetical character (see FIG. 4).

As an example, when the terminal user 120 desires to input a Roman alphabetical character ‘G’, the terminal user 120 may input the key buttons 4 and 7 of the terminal 110 where symbol characters are arranged as illustrated in FIG. 4. In this instance, the character input system 200 may extract symbol characters [symbol] and [symbol] and thereby generate a combined symbol character [symbol] The generated combined symbol character [symbol] may be identified as a Roman alphabetical character ‘G’ by a plurality of unspecific persons, and may be controlled to be displayed on the display of the terminal 110.

Even a process of inputting other Roman alphabetical characters may be similar to the process of inputting the Roman alphabetical character ‘G’. Specifically, the terminal user 120 may input a particular Roman alphabetical character by pushing key buttons of symbol characters, which are required to constitute a known Roman alphabetical character. Descriptions related to a combination of symbol characters with respect to each of Roman alphabetical characters have been made with reference to FIG. 4, and thus further detailed descriptions will be omitted.

A method of inputting Roman alphabetical characters according to the present invention is performed by the character input system 200.

The character input system 200 maintains the table 210 which stores a symbol character corresponding to a key button input signal. As described above, to express Roman alphabetical characters, each of the symbol characters, [symbol] [symbol] and [symbol] is allocated to each of key buttons of the terminal respectively. Also, associated information is stored in the table 210.

Also, the character input system 200 receives at least one key button input signal, which is generated in association with a key button input, from the terminal 110. Through the operation, it is possible to check that the terminal user 120 pushed a key button to input a particular Roman alphabetical character.

The character input system 200 extracts a combined symbol character corresponding to each key button input signal by referring to the table 210.

The extracted combined symbol character is displayed on the display of the terminal 110. In the case of Roman alphabetical characters, the combined symbol character may be generated into [symbol] [symbol] [symbol] [symbol] and the like. As well-known to those of ordinary skills, each combined symbol characters corresponds to each of Roman alphabetical characters A to Z (see FIG. 4).

Thus, according to the present invention, a combined symbol character corresponding to a desired Roman alphabetical character may be generated by only inputting a stroke (symbol character) which is acquired by disassembling the Roman alphabetical character. Through the operation, a character input rule may be simplified.

Particularly, according to the present invention, since symbol characters, which constitute a single combined symbol character, are not affected by subsequently inputted symbol characters, the symbol characters may be inputted without a mistype.

As an example, when the terminal user 120 desires to input Roman alphabetical characters ‘C, G, and X’, the terminal user 120 may consecutively push corresponding key buttons ‘44779’. The character input system 200 may extract symbol characters [symbol] and [symbol] corresponding to the pushing operations. Next, the character input system 200 combines the extracted symbol characters [symbol] and [symbol] into combined symbol characters [symbol] and [symbol] Specifically, the character input system 200 may automatically classify the extracted symbol characters into [symbol] and [symbol] and precisely combine the same into the combined symbol characters [symbol] and [symbol] Since a combined symbol character by, for example, a combination of [symbol] and [symbol] does not exist, the character input system 200 may easily classify the extracted symbol characters [symbol] and [symbol] into [symbol] and

[symbol]

Thus, according to the present invention, a character may be quickly inputted without a mistype in an input system and a waiting input time, and also with a comparatively small number of input strokes.

According to an embodiment of the present invention, the above-described Roman alphabetical character input method may be applicable as is to a method of inputting characters of at least one different language using Roman alphabetical characters.

Examples of combined symbols for Latin-derived languages, Germanic-derived languages, West Slavic-derived languages, South Slavic-derived languages, Asian-derived languages, and the like, and added combined symbols and diacritics, which are used for inputting a corresponding language, are illustrated in Table 1 below. A group of Latin derived languages includes a Latin language, an Italian language, a French language, a Spanish language, a Portuguese language, a Romanian language, a Catalonia language, a Basque language, a Rhaeto-Romanic language, and a Provenial language. A group of Germanic-derived languages includes a German language, a Netherlandic language, a Danish language, a Norwegian language, and a Swedish language. A group of Celtic-derived languages includes a Breton language, a Welsh language, and an Albanian language. A group of West Slavic-derived languages includes a Czech language, a Slovak language, a Polish language, a Kashubian language, and a Wend language. A group of South Slavic-derived languages includes a Slovenian language and a Serbian-Croatian language. Also, a group of Asian-derived Languages includes a Hungarian language, a Finnish language, a Turkish language, and a Kurdish language.

Referring to Table 1, examples of symbol marks with respect to at least one language using Roman alphabetical characters, and additional symbol marks or diacritics, which are allocated to at least one portion of key buttons of a keypad of a terminal, according to the present invention are illustrated. As described above, in a method of inputting characters of at least one language using Roman alphabetical characters according to the present invention, symbol marks similar to Roman alphabetical characters may be allocated to key buttons of a keypad. Also, characters of each language may be inputted by the same symbol and input method to the above-described Roman alphabetical character input method. In this instance, a plurality of diacritic symbols of a corresponding year language is additionally allocated to three key buttons ‘*’, ‘0’, and ‘#’. Also, a Roman alphabetical character added with a diacritic is inputted by the same method as the Roman alphabetical character input method. When a key button allocated with a diacritic is pushed, a diacritic corresponding to a previously inputted character is automatically recognized, and thus automatically converted into a character with the diacritic and thereby inputted.

Referring to Table 1, as described above, the character input method with respect to at least one language using Roman alphabetical characters may be applicable to a borrowed sound input method of inputting characters of the terminal user's 120 mother language by using a Roman alphabetical character notation system corresponding to a phonetic value of the terminal user's 120 mother language.

Arabic Character Input

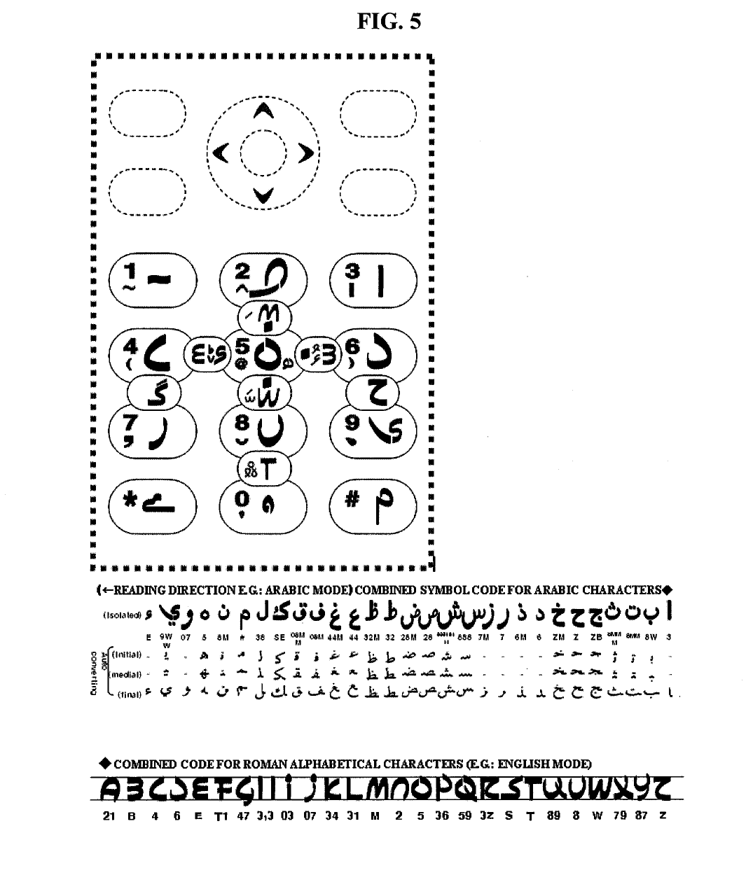

According to another embodiment of the present invention, FIG. 5 illustrates a method of composing Arabic characters by allocating symbol characters associated with Arabic characters to each key button, which are arranged in a form of a 7×5 matrix or a 5×7 matrix, and extracting the allocated symbol characters according to the terminal user's 120 key button input.

FIG. 5 is a diagram illustrating a structure of a terminal keypad, which is utilized for a Roman alphabetical character input method, and a method of inputting a combined symbol character according to a key button input signal, which is included in the terminal keypad, according to the present invention.

To express Arabic characters, the present inventor selected symbol characters, [symbol] [symbol] [symbol] (top dot), [symbol] (bottom dot), [symbol] (right dot), [symbol] (Hamza), [symbol] and [symbol] . Also, the symbol characters may be allocated to key buttons of the terminal 110 respectively, based on a usage frequency, character input convenience for the terminal user 120, and the like. Also, the operator may allocate dot ‘’ to a twin-tap key button of ‘M, W, E, and B’ by considering a location where the dot is placed.

As an example, referring to FIG. 5, each of the symbol characters [symbol] [symbol] [symbol] (top dot), [symbol] (bottom dot), [symbol] (right dot), [symbol] (Hamza), [symbol] and [symbol] is allocated to each of independent key buttons 1 to 0, and twin-tap key buttons. Also, a plurality of vowels and symbol marks [symbol] is randomly allocated to key buttons and inputted when pushing a corresponding key button for about 0.6 second. Thus, the pronunciation of foreign languages and newly-coined words may be precisely inputted.

In this instance, when the terminal user 120 arbitrarily pushes key buttons, the character input system 200 may extract a symbol character associated with each of the pushed key buttons, and combine extracted symbol characters into a combined symbol character to correspond to a corresponding Arabic character (see FIG. 5).

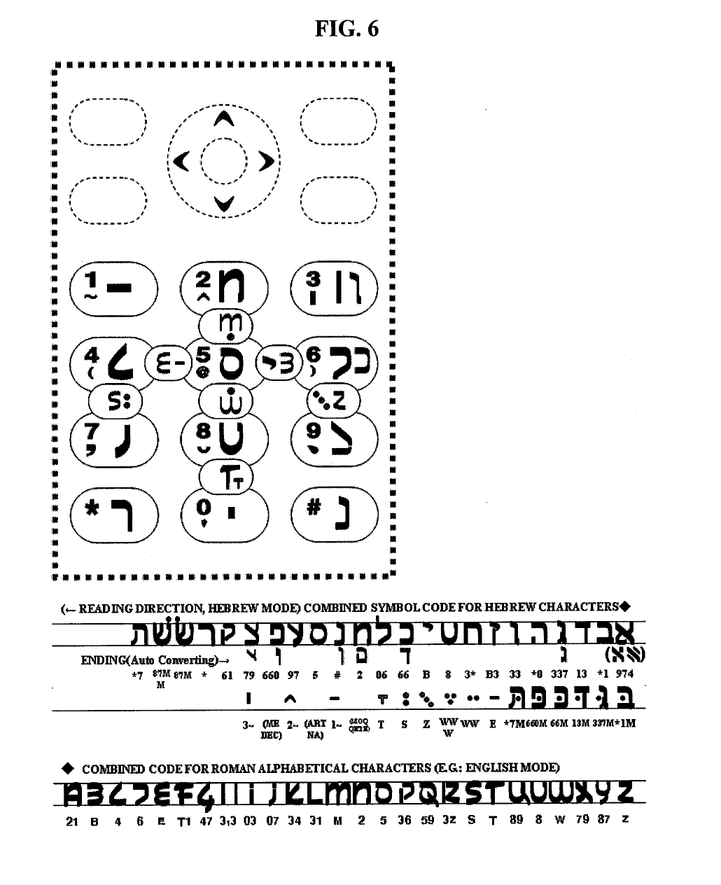

As an example, when the terminal user 120 desires to input an Arabic character [symbol] the terminal user 120 may input key buttons ‘2’ and ‘8’ of the terminal 110 where symbol characters are arranged as illustrated in FIG. 6, and a twin-tap key button ‘M’ for inputting the top dot ‘’. In this instance, the character input system 200 may extract symbol characters [symbol] and [symbol] associated with the key buttons ‘2’ and ‘8’, combine the extracted symbol characters into [symbol] and combine [symbol] and the top dot ‘’ and thereby generate a combined symbol character [symbol] .

Specifically, the terminal user 120 may input a particular Arabic character by pushing key buttons of symbol characters which are required to constitute the Arabic character by considering an external shape of the known Arabic character. Descriptions related to a combination of symbol characters with respect to each Arabic character have been made with reference to FIG. 5, and thus further detailed descriptions will be omitted.

A method of inputting Arabic characters according to the present invention is performed by the character input system 200 as described above.

The character input system 200 maintains the table 210 which stores a symbol character corresponding to a key button input signal. In this instance, each of the symbol characters, [symbol] [symbol] [symbol] (top dot), [symbol] (bottom dot), [symbol] (right dot), [symbol] (Hamza), [symbol] and [symbol] is allocated to each key button of the terminal 110.

Also, the character input system 200 receives at least one key button input signal, which is generated in association with a key button input, from the terminal 110. Through the operation, it is possible to check that the terminal user 120 pushed a key button to input a particular Arabic character. Also, when pushing a key button, not a conventional method of inputting a single character within a predetermined period of time, but a method of continuously inputting symbol characters or the dot is utilized. Specifically, since a waiting input time is not required, a character input time may be reduced.

The character input system 200 extracts at least one symbol character corresponding to each key button input signal, from the table 210, and generates a combined symbol character by combining the extracted at least one symbol character.

Also, the character input system 200 generates a combined symbol character by combining at least one symbol character according to an Arabic character composition principle. In the case of Arabic characters, the combined symbol character may include [symbol] [symbol] [symbol] [symbol] and the like. Each combined symbol character corresponds to each respective Arabic character (see FIG. 5).

The character input system 200 controls the generated combined symbol character to be displayed on a display of the terminal 110. According to another embodiment of the present invention, the character input system 200 searches the table 210 for a character corresponding to a combination of symbols, and displays the retrieved character on the display. In this instance, the displayed character may be a general Arabic character or a symbol character.

Thus, according to the present invention, a combined symbol character corresponding to a desired Arabic character may be generated by only inputting a stroke (symbol character) which is acquired by disassembling the Arabic character. Through the operation, a character input rule may be simplified. Also, according to the present invention, since a single symbol character is allocated to each key button for easy input, a symbol character may be more easily inputted.

Particularly, according to the present invention, since symbol characters, which constitute a single combined symbol character, are not affected by subsequently inputted symbol characters, the symbol characters may be inputted without a mistype.

As an example, when the terminal user 120 desires to input Arabic characters [symbol] and [symbol] the terminal user 120 may push key buttons ‘28M888W’ in row. The character input system 200 may extract symbol characters [symbol] [symbol] and ’ corresponding to the pushing operations. Next, the character input system 200 may generate combined symbol characters [symbol] and [symbol] by combining the extracted symbol characters [symbol] [symbol] and ’. Specifically, the character input system 200 may automatically classify the extracted symbol characters into [symbol] ’, [symbol] and [symbol] ’, and precisely combine the same into the combined symbol characters [symbol] and [symbol] Since a combined symbol character by, for example, a combination of [symbol] , [symbol] or [symbol] ’ does not exist, the character input system 200 may easily classify the extracted symbol characters [symbol] [symbol] and ’ into [symbol] ’, [symbol] and [symbol] ’.

Thus, according to the present invention, a character may be quickly inputted without a mistype in an input system and a waiting input time, and also with a comparatively small number of input strokes.

Examples of combined symbols for inputting at least one language, which includes a Turkish language, a Persian language using Arabic characters, and the like, and added combined symbols and diacritics which are used for inputting a corresponding language, are illustrated in Table 2 below. Referring to Table 2, examples of symbol marks with respect to at least one language using Arabic characters, and added symbol marks or diacritics, which are allocated to key buttons of a keypad of a terminal, according to the present invention are illustrated. The symbol marks may be automatically classified into characters according to an Arabic character composition principle via an input signal with respect to the symbol marks, and automatically converted with a character which is attached with a vowel mark, and character types of an independent type, a head word type, a middle word type, and a tail word type, according to a location of the inputted symbol mark.

Hebrew Character Input

According to another embodiment of the present invention, FIG. 6 illustrates a method of composing Hebrew characters by allocating symbol characters associated with Hebrew characters to each of key buttons, which are arranged in a form of a 7×5 matrix or a 5×7 matrix, and extracting the allocated symbol characters according to the terminal user's 120 key button input.

FIG. 6 is a diagram illustrating a structure of a terminal keypad, which is utilized for a Cyrillic character input method, and a method of inputting a combined symbol character according to a key button input signal, which is included in the terminal according to the present invention

To express Hebrew characters, the present inventor selected symbol characters, [symbol] [symbol] (Dagesh, top dot), , , [symbol] [symbol] and [symbol] Also, the symbol characters may be allocated to key buttons of the terminal 110 respectively, based on a usage frequency, character input convenience for the terminal user 120, and the like. Also, a plurality of symbol characters in a similar shape may be associated with a single key button, and a second place located symbol character may be inputted by pushing a corresponding key button twice.

As an example, referring to FIG. 6, each of the symbol characters, [symbol] [symbol] and [symbol] is allocated to each of independent key buttons 1 to 0, 0, *, and #. Also, each of the symbol characters, ‘(Dagesh, top dot), , , [symbol] [symbol] and [symbol] is allocated to each of twin-tap key buttons, ‘M, W, B, B, S, T, and Z’. Also, a plurality of symbol characters [symbol] and [symbol] which have a similar shape, may be associated with the independent key buttons ‘3’ and ‘6’, and may be selectively inputted according to the terminal user's 120 number of pushing operations.

In this instance, when the terminal user 120 arbitrarily pushes key buttons, the character input system 200 may extract a symbol character associated with each of the pushed key buttons, and combine the extracted symbol characters into a combined symbol character to correspond to a corresponding Hebrew character (see FIG. 6).

As an example, when the terminal user 120 desires to input a Hebrew character [symbol] the terminal user 120 may input key buttons ‘7’ and ‘9’ of the terminal 110 where symbol characters are arranged as illustrated in FIG. 6. In this instance, the character input system 200 may extract symbol characters [symbol] and [symbol] associated with the key buttons ‘7’ and ‘9’, and combine the same and thereby generate a combined symbol character

[symbol]

Also, when the terminal user 120 desires to input a Hebrew character [symbol] the terminal user 120 may push the key button ‘3’ of the terminal 110 where symbol characters are arranged as illustrated in FIG. 6 twice. In this instance, the character input system 200 may extract a symbol character (combined symbol character) [symbol] associated with the twice pushed key button ‘3’.

Specifically, the terminal user 120 may input a particular Hebrew character by pushing key buttons of symbol characters, which are required to constitute the Hebrew character, by considering an external shape of the known Hebrew character. Descriptions related to a combination of symbol characters with respect to each Hebrew character have been made with reference to FIG. 6, and thus further detailed descriptions will be omitted.

A method of inputting Hebrew characters according to the present invention is performed by the character input system 200 as described above.

The character input system 200 maintains the table 210 which stores a symbol character corresponding to a key button input signal, and a combined symbol character. According to an embodiment of the present invention, as illustrated in FIG. 6, to indicate Hebrew characters, each of the symbol characters, [symbol] [symbol] (Dagesh, top dot), , , [symbol] [symbol] and [symbol] is allocated to each key button of the terminal 110. Also, associated information is stored in the table 210.

Also, the character input system 200 receives at least one key button input signal, which is generated in association with a key button input, from the terminal 110. Next, the character input system 200 extracts at least one symbol character corresponding to the at least one key button input signal from the table 210.

Also, the character input system 200 generates a combined symbol character by combining the extracted at least one symbol character according to a Hebrew character composition principle. In this instance, the generated Hebrew character may include consonants, such as [symbol] [symbol] [symbol] and [symbol] and characters which are generated by attaching vowel marks of ‘(Dagesh, top dot), , , [symbol] and [symbol] to each of the consonant, and the like. Also, as illustrated in FIG. 6, each of combined symbol characters corresponds to each of Hebrew characters.

The character input system 200 controls the generated combined symbol character to be displayed on a display of the terminal 110. The character input system 200 may search the table 210 for a symbol character shape or a printing type shape which is displayed on the display, and control the retrieved symbol character to be displayed on the display.

Thus, according to the present invention, a combined symbol character corresponding to a desired Hebrew character may be generated by only inputting a stroke (symbol character) which is acquired by disassembling the Hebrew character. Through the operation, a character input rule may be simplified. Also, according to the present invention, since a single symbol character is allocated to each key button for easy input, a symbol character may be more easily inputted.

Particularly, according to the present invention, since symbol characters, which constitute a single combined symbol character, are not affected by subsequently inputted symbol characters, the symbol characters may be inputted without a mistype.

As an example, when the terminal user 120 desires to input Hebrew characters [symbol] and [symbol] the terminal user 120 may consecutively push key buttons ‘*77997’. The character input system 200 may extract symbol characters [symbol] and [symbol] corresponding to the pushing operations. Next, the character input system 200 may generate combined symbol characters [symbol] and [symbol] by combining the extracted symbol characters [symbol] and [symbol] Specifically, the character input system 200 may automatically classify the extracted symbol characters into [symbol] and [symbol] and precisely combine the same into the combined symbol characters [symbol] and [symbol] Since a combined symbol character by, for example, a combination of [symbol] or [symbol] does not exist, the character input system 200 may easily classify the extracted symbol characters [symbol] and [symbol] into [symbol] and

[symbol]

Thus, according to the present invention, a character may be quickly inputted without a mistype in an input system and a waiting input time, and also with a comparatively small number of input strokes.

Cyrillic Character Input

When expressing Cyrillic characters according to the present invention, it is possible to express a phonetic value by using the above-described Roman alphabetical characters, and convert the phonetic value of each Roman alphabetical character into a Cyrillic character corresponding to the phonetic value. For the operation, the table 210 may store Cyrillic characters, and the input signal analysis unit 240 may search the table 210 for a Cyrillic character corresponding to an expressed phonetic value and display the retrieved Cyrillic character on a predetermined display.

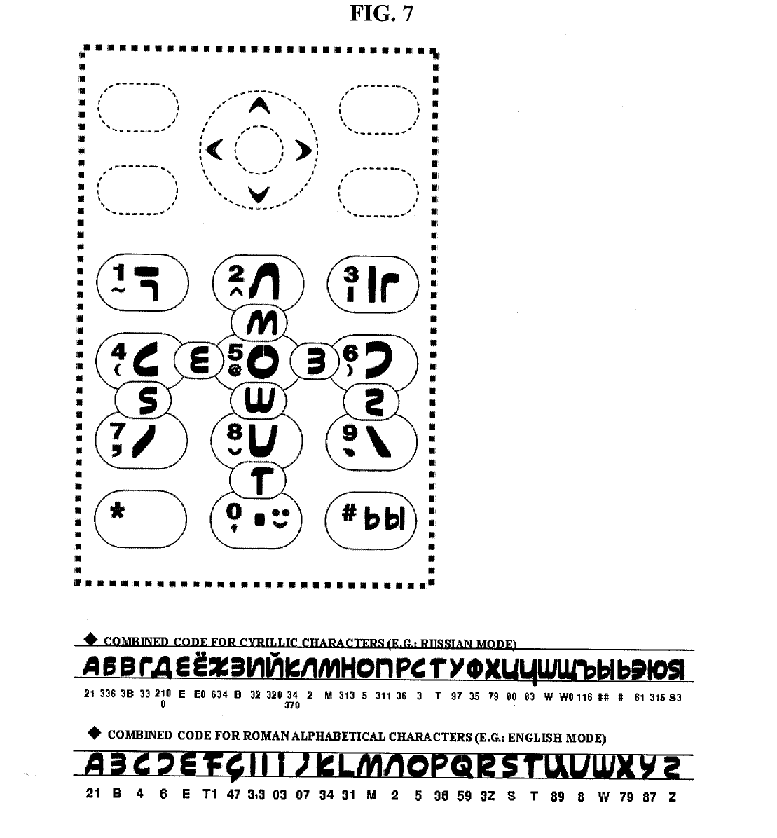

Also, according to another embodiment of the present invention, FIG. 7 illustrates a method of inputting a Cyrillic character by allocating symbol characters associated with Cyrillic characters to each key button, which are arranged in a form of a 7×5 matrix or a 5×7 matrix, and extracting the allocated symbol characters according to the terminal user's 120 key button input.

FIG. 7 is a diagram illustrating a structure of a terminal keypad, which is utilized for a Cyrillic character input method, and a method of inputting a combined symbol character according to a key button input signal, which is included in the terminal according to the present invention.

To indicate Cyrillic characters, the present inventor selected symbol characters, [symbol] [symbol] [symbol] and [symbol] Also, the symbol characters may be allocated to key buttons of the terminal 110 respectively, based on a usage frequency, character input convenience for the terminal user 120, and the like. Also, a plurality of symbol characters in a similar shape may be associated with a single key button, and a second place located symbol character may be inputted by pushing a corresponding key button twice.

As an example, referring to FIG. 7, each of the symbol characters, [symbol] [symbol] [symbol] and [symbol] is allocated to each of independent key buttons 1 to 0, *, and #. Also, each of the symbol characters, [symbol] and [symbol] is allocated to each of twin-tap key buttons, ‘M, W, E, B, S, T, and Z’. As an example, the symbol character [symbol] may be selectively extracted according to the terminal user's 120 number of pushing operations by allocating a second symbol character [symbol] with a similar shape to the key button 3.

In this instance, when the terminal user 120 arbitrarily pushes key buttons, the character input system 200 may extract a symbol character associated with each of the pushed key buttons, and combine extracted symbol characters into a combined symbol character to correspond to a corresponding Cyrillic character (see FIG. 7).

As an example, when the terminal user 120 desires to input a Cyrillic character [symbol] the terminal user 120 may input key buttons ‘2,1,0,0’ of the terminal 110 where symbol characters are arranged as illustrated in FIG. 7. In this instance, the character input system 200 may extract symbol characters [symbol] and [symbol] and combine the same, and thereby generate a combined symbol character

[symbol]

Specifically, the terminal user 120 may input a particular Cyrillic character by pushing key buttons of symbol characters which are required to constitute the Cyrillic character by considering an external shape of the known Cyrillic character. Descriptions related to a combination of symbol characters with respect to each Cyrillic character have been made with reference to FIG. 7, and thus further detailed descriptions will be omitted.

A method of inputting Cyrillic characters according to the present invention is performed by the character input system 200 as described above.

The character input system 200 maintains the table 210 which stores a symbol character corresponding to a key button input signal, and a combined symbol character. According to an embodiment of the present invention, as illustrated in FIG. 7, each of the symbol characters, [symbol] [symbol] [symbol] and [symbol] is allocated to each of key buttons of the terminal 110. Also, associated information is stored in the table 210.

Also, the character input system 200 receives at least one key button input signal, which is generated in association with a key button input, from the table 110. Next, the character input system 200 extracts at least one symbol character corresponding to the key button input signal from the table 210. Particularly, the character input system 200 may search the table 210 for a character type by considering a servicing language or the terminal user's 120 usage language group. Also, the character input system 200 may select a symbol character to be extracted only with respect to a group of symbol characters which are stored for the retrieved character type.

Also, the character input system 200 generates a combined symbol character by combining the extracted at least one symbol character according to a Cyrillic character composition principle. In this instance, in the case of Cyrillic characters, the generated combined symbol character may include [symbol] [symbol] [symbol] [symbol] [symbol] and the like. As illustrated in FIG. 7, each combined symbol character has a corresponding Cyrillic character.

The character input system 200 controls the generated combined symbol character to be displayed on a display of the terminal 110. The character input system 200 may search the table 210 for a symbol character shape or a printing type shape which is displayed on the display, and control the retrieved symbol character to be displayed on the display.

Thus, according to the present invention, a combined symbol character corresponding to a desired Cyrillic character may be generated by only inputting a stroke (symbol character) which is acquired by disassembling the Cyrillic character. Through the operation, a character input rule may be simplified. Also, according to the present invention, since a single symbol character is allocated to each key button for easy input, a symbol character may be more easily inputted.

Particularly, according to the present invention, since symbol characters, which constitute a single combined symbol character, are not affected by subsequently inputted symbol characters, the symbol characters may be inputted without a mistype.

As an example, when the terminal user 120 desires to input Cyrillic characters [symbol] and [symbol] the terminal user 120 may consecutively push key buttons ‘33336634’. The character input system 200 may extract symbol characters [symbol] and [symbol] corresponding to the pushing operations. Next, the character input system 200 may generate combined symbol characters [symbol] and [symbol] by combining the extracted symbol characters [symbol] and [symbol] Specifically, the character input system 200 may automatically classify the extracted symbol characters into [symbol] and [symbol] and precisely combine the same into the combined symbol characters [symbol] and [symbol] Since a combined symbol character by, for example, a combination of [symbol] and [symbol] or [symbol] and [symbol] does not exist, the character input system 200 may easily classify the extracted symbol characters [symbol] into [symbol] and

[symbol]

Thus, according to the present invention, a character may be quickly inputted without a mistype in an input system and a waiting input time, and also with a comparatively small number of input strokes.

Examples of combined symbols for inputting at least one language, which includes a West Slavic-derived language, a Latin-derived language, an Iranian-derived language, and the like, using Cyrillic characters, and added combined symbols, which are used for inputting a corresponding language, are illustrated in Table 3 below. Referring to Table 3, examples of symbol marks with respect to at least one language using Cyrillic characters, and added symbol characters which are allocated to key buttons of a keypad of a terminal, according to the present invention are illustrated. The symbol marks may be automatically classified into characters according to a Cyrillic character composition principle via an input signal with respect to the symbol marks.

Greek Character Input

When expressing Greek characters according to the present invention, it is possible to express a phonetic value by using the above-described Roman alphabetical characters, and convert the phonetic value of each Roman alphabetical character into a Greek character corresponding to the phonetic value. For the operation, the table 210 may store Greek characters, and the input signal analysis unit 240 may search the table 210 for a Greek character corresponding to an expressed phonetic value and display the retrieved Greek character on a predetermined display.

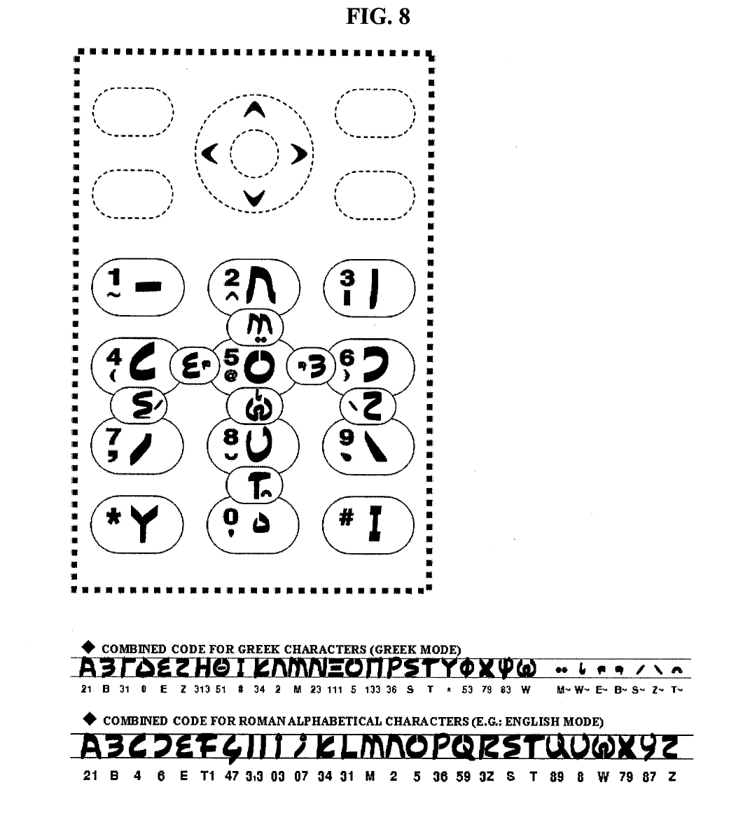

Also, according to another embodiment of the present invention, FIG. 8 illustrates a method of inputting a Greek character by allocating symbol characters associated with Greek characters to each key button, which are arranged in a form of a 7×5 matrix or a 5×7 matrix, and extracting the allocated symbol characters according to the terminal user's 120 key button input.

FIG. 8 is a diagram illustrating a structure of a terminal keypad, which is utilized for a Greek character input method, and a method of inputting a combined symbol character according to a key button input signal, which is included in the terminal according to the present invention.

To indicate Greek characters, the present inventor selected symbol characters, ‘ [symbol] [symbol] [symbol] and [symbol] Also, the symbol characters may be allocated to key buttons of the terminal 110 respectively, based on a usage frequency, character input convenience for the terminal user 120, and the like. Also, a plurality of symbol characters in a similar shape may be associated with a single key button, and a second place located symbol character may be inputted by pushing a corresponding key button twice.

As an example, referring to FIG. 8, each of the symbol characters, [symbol] [symbol] and [symbol] is allocated to each of independent key buttons 1 to 0, *, and #. Also, each of the symbol characters, [symbol] and [symbol] is allocated to each of twin-tap key buttons ‘M, W, B, B, S, T, and Z’.

In this instance, when the terminal user 120 arbitrarily pushes key buttons, the character input system 200 may extract a symbol character associated with each of the pushed key buttons, and combine extracted symbol characters into a combined symbol character to correspond to a corresponding Greek character (see FIG. 8).

As an example, when the terminal user 120 desires to input a Greek character [symbol] the terminal user 120 may input key buttons ‘3,1,3’ of the terminal 110 where symbol characters are arranged as illustrated in FIG. 8. In this instance, the character input system 200 may extract symbol characters [symbol] and [symbol] associated with the key buttons ‘3, 1, 3’ respectively, and combine the extracted symbol character and thereby generate a combined symbol character

[symbol]

Specifically, the terminal user 120 may input a particular Greek character by pushing key buttons of symbol characters which are required to constitute the Greek character by considering an external shape of the known Greek character. Descriptions related to a combination of symbol characters with respect to each greek character have been made with reference to FIG. 8, and thus further detailed descriptions will be omitted.

A method of inputting Greek characters according to the present invention is performed by the character input system 200 as described above.

The character input system 200 maintains the table 210 which stores a symbol character corresponding to a key button input signal, and a combined symbol character. According to an embodiment of the present invention, as illustrated in FIG. 8, each of the symbol characters, [symbol] [symbol] [symbol] and [symbol] is allocated to each key button of the terminal 110. Also, associated information is stored in the table 210.

Also, the character input system 200 receives at least one key button input signal, which is generated in association with a key button input, from the terminal 110. Next, the character input system 200 extracts at least one symbol character corresponding to the key button input signal from the table 210. Particularly, the character input system 200 may search the table 210 for a character type by considering a servicing language or the terminal user's 120 usage language group. Also, the character input system 200 may select a symbol character to be extracted only with respect to a group of symbol characters which are stored for the retrieved character type.

Also, the character input system 200 generates a combined symbol character by combining the extracted at least one symbol character according to a Greek character composition principle. In this instance, in the case of Greek characters, the generated combined symbol character may include [symbol] [symbol] [symbol] and the like. As illustrated in FIG. 8, each of combined symbol characters corresponds to each of Greek characters.

The character input system 200 controls the generated combined symbol character to be displayed on a display of the terminal 110. Also, the character, which is displayed on the display by the character input system 200, may have an external shape of a combined symbol character which is generated by combining symbol characters according to the present invention. According to another embodiment, the character input system 200 may search the table 210 for a printing type Greek character which has a comparatively high similarity in the external shape with the generated combined symbol character. The character input system 200 may control the printing type Greek character to be displayed on the display. In this instance, the printing type Greek character may be easily recognized by a plurality of unspecific persons (Greek character users).

Thus, according to the present invention, a combined symbol character corresponding to a desired Greek character may be generated by only inputting a stroke (symbol character) which is acquired by disassembling the Greek character. Through the operation, a character input rule may be simplified. Also, according to the present invention, since a single symbol character is allocated to each key button for easy input, a symbol character may be more easily inputted.

Particularly, according to the present invention, since symbol characters, which constitute a single combined symbol character, are not affected by subsequently inputted symbol characters, the symbol characters may be inputted irrespective of a predetermined period of time (waiting character input time).

Thus, according to the present invention, a character may be quickly inputted without a mistype in an input system and a waiting input time.

Chinese Character Input

When expressing Chinese characters according to the present invention, it is possible to input a Chinese character corresponding to PINYIN by using the above-described Roman alphabetical characters. For the operation, the table 210 may store Chinese characters, and the input signal analysis unit 240 may search the table 210 for a Chinese character corresponding to an expressed phonetic value and display the retrieved Chinese character on a predetermined display.

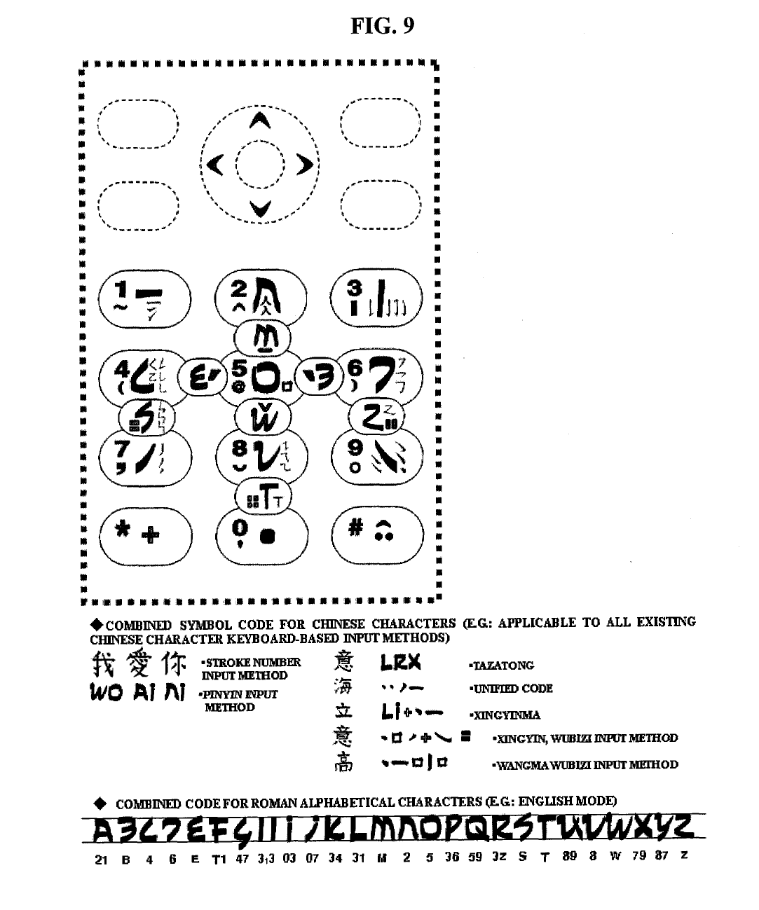

Also, according to another embodiment of the present invention, FIG. 9 illustrates a method of inputting a Chinese character by allocating symbol characters associated with Chinese characters to each key button, which are arranged in a form of a 7×5 matrix or a 5×7 matrix, and extracting the allocated symbol characters according to the terminal user's 120 key button input.

FIG. 9 is a diagram illustrating a structure of a terminal keypad, which is utilized for a Chinese character input method, and a method of inputting a combined symbol character according to a key button input signal, which is included in the terminal 110 according to the present invention.

To express Chinese characters, the present inventor selected symbol characters, [symbol] [symbol] [symbol] and Chinese SHENGDIAO symbols [symbol] Also, the symbol characters may be allocated to key buttons of the terminal 110 respectively, based on a usage frequency, character input convenience for the terminal user 120, and the like. Also, a plurality of symbol characters in a similar shape may be associated with a single key button, and a symbol character located second may be inputted by pushing a corresponding key button twice.

As an example, referring to FIG. 9, each of the symbol characters, [symbol] [symbol] and [symbol] is allocated to each of independent key buttons 1 to 0, *, and #. Also, each of the symbol characters, [symbol] and [symbol] is allocated to each of twin-tap key buttons ‘M, W, E, B, S, T, is Z’.

Examples of Chinese character input method include a combined stroke input method of inputting a symbol character in a stroke order of a Chinese character and selecting a candidate Chinese character or word, a PINYIN single tap prediction input method of inputting PINYIN as a symbol character (single tap) corresponding to an alphabetical character, and selecting a candidate Chinese character or word which includes the inputted PINYIN.

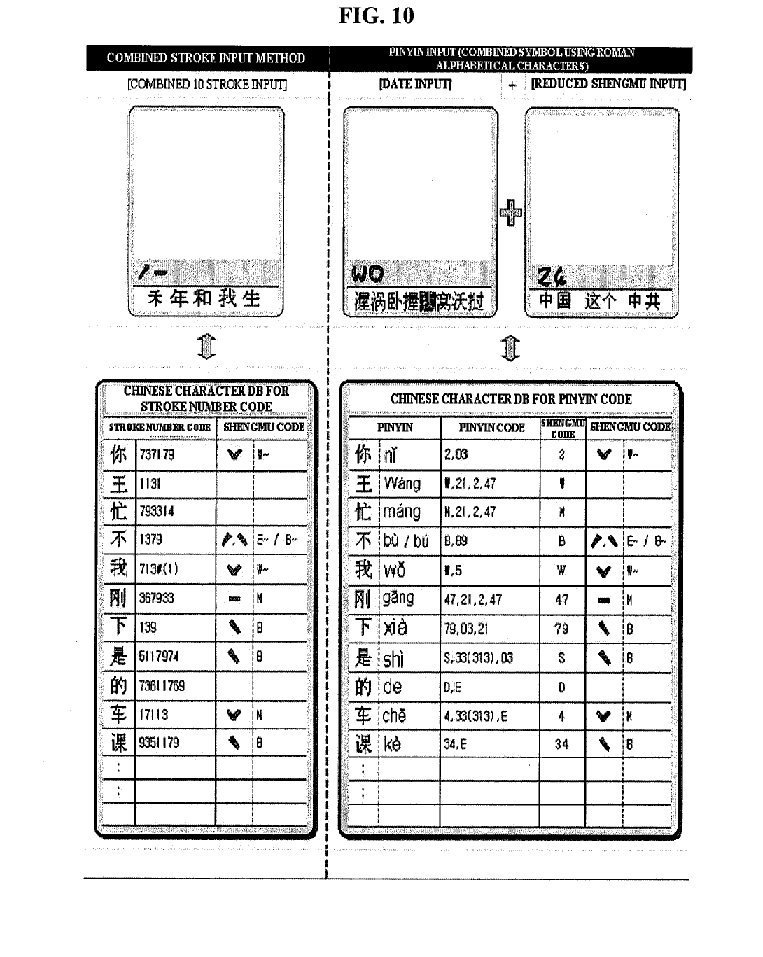

FIG. 10 is a diagram illustrating an example of a combined stroke input method and a PINYIN input method via the terminal keypad illustrated in FIG. 9.

A method of inputting a Chinese character by the combined stroke input method will be described with reference to FIG. 10.

When the terminal user 120 arbitrarily pushes key buttons, the character input system 200 extracts a symbol character associated with each of the pushed key buttons, sequentially combines the extracted symbol characters, and thereby generates a combined symbol character.

As an example, when the user terminal 120 desires to input a Chinese character [symbol] the terminal user 120 may sequentially input key buttons ‘1, 3, 7, 9, . . . ’ of the terminal 110, which is arranged with symbol characters, in a Chinese character writing order. In this instance, the character input system 200 may sequentially combine symbol characters [symbol] . . . ’, which are extracted in correspondence to the inputted key buttons ‘1, 3, 7, 9, . . . ’ and thereby generate combined symbol characters ‘-, [symbol] . . . ’. Every time the combined symbol character is generated, the character input system 200 may display candidate Chinese characters or words, which include the combined symbol character, on the display of the terminal 110, and then wait for the terminal user 120 to select a desired Chinese character or word.

As an example, when the combined symbol character [symbol] is generated, the character input system 200 may display candidate Chinese characters, [symbol] . . . ’, on the display. In this instance, the candidate Chinese characters may be extracted from the table 210 which maintains printing type Chinese characters. Also, the character input system 200 may retrieve all the printing type Chinese character, which include [symbol] as the candidate Chinese characters, and provide the retrieved candidate Chinese characters to the terminal 110.

The PINYIN input method will be described with reference to FIG. 10. In this instance, the PINYIN input method may be classified into two types.

1) PINYIN syllable input method: displays homophonic candidate Chinese characters when PINYIN is inputted as a combined symbol of Roman alphabetical characters per syllabic unit. When continuously pushing a SHENGDIAO mark button among a single character, which is inputted as PINYIN, only candidate Chinese characters corresponding to a corresponding SHENGDIAO are displayed. To utilize the PINYIN syllable input method, a Chinese character database illustrated in FIG. 10 may be further included.

2) PINYIN reduced SHENGMU input method: displays candidate Chinese word, which are matched with pushed SHENGMU, when PINYIN is inputted as a combined Roman alphabetical character symbol, and in this instance, only each initial character of SHENGMU of a desired word is continuously pushed. When SHENGDIAO (continuously pushing a mark button) is inputted for each SHENGMU, a minimum number of candidate Chinese characters will be outputted. To utilize the PINYIN reduced SHENGMU input method, a Chinese character database illustrated in FIG. 10 may be further included.

The Chinese character input method according to the present invention may simultaneously utilize the PINYIN syllable input method and the PINYIN reduced SHENGMU input method, as described above. In this instance, the Chinese character database illustrated in FIG. 10 must be installed in a terminal for inputting a Chinese character.

When the terminal user 120 arbitrarily pushes key buttons, the character input system 200 may extract a symbol character associated with each of the pushed key buttons, and sequentially combine the extracted symbol character and thereby generate a combined symbol character.

As an example, when the terminal user 120 desires to input a Chinese character [symbol] the terminal user 120 may sequentially input key buttons ‘z, 33, 5, and 2’ of the terminal 110, which is arranged with symbol characters, according to PINYIN ‘z, h, o, n, g’. In this instance, the character input system 200 may generate a combined symbol character [symbol] corresponding to the PINYIN ‘z, h, o, n’. Also, every time the combined symbol character is generated, the character input system 200 may display candidate Chinese characters or words, which include the combined symbol character, on a display of the terminal 110, and then wait for the terminal user 120 to select a desired Chinese character. As an example, when a combined symbol character [symbol] is generated, the character input system 200 may display candidate words, [symbol] . . . ’, on the display. In this instance, the candidate words may be extracted from, for example, the second memory (not illustrated). Also, the character input system 200 may retrieve all Chinese words, which include ‘zon’ as PINYIN, as candidate words, and then provide the retrieved candidate words to the terminal 110.

Specifically, the terminal user 120 may partially input a Chinese character by pushing key buttons of symbol characters which are required to constitute the Chinese character, based on an external shape of the known Chinese character or PINYIN. Also, the character input system 200 may provide candidate Chinese characters or words, which include the partially inputted PINYIN, to the terminal user 120, receive a selection from the terminal user 120, and thereby enable an input of a complete word. Particularly, the Chinese input system 200 may select the candidate Chinese characters or words with reference to other terminal users' selection frequency, usage frequency of a particular reference material, and the like, and provide optimal Chinese characters or words to the terminal user 120 as candidates.

Thus, according to the present invention, a combined symbol character corresponding to a desired Chinese character may be generated by only inputting a stroke (symbol character) which is acquired by disassembling the Chinese character. Through the operation, a character input rule may be simplified. Also, according to the present invention, a Chinese character may be inputted by considering a portion of the Chinese character according to a stroke order or PINYIN of the Chinese character. Thus, a Chinese character input time may be significantly reduced by selecting an associated candidate Chinese character or word.

Also, a QWETRY keyboard-based Chinese character input method includes a WUBIZI input method, a WANGMA WUBIZI input method, TAZATONG, a unified code, a Chinese character model input method, and the like. The above-described input methods utilize an algorithm of combining and inputting Chinese character composition elements, such as ‘a number of strokes, ZIGEN, PINYIN, ZIXING’, and the like. According to the present invention, the existing keyboard-based Chinese character input technologies may be applicable to the Chinese character input keypad system according to the present invention by unifying a number of strokes of a Chinese character and a Roman alphabetical character input method.

HANGUL Character Input

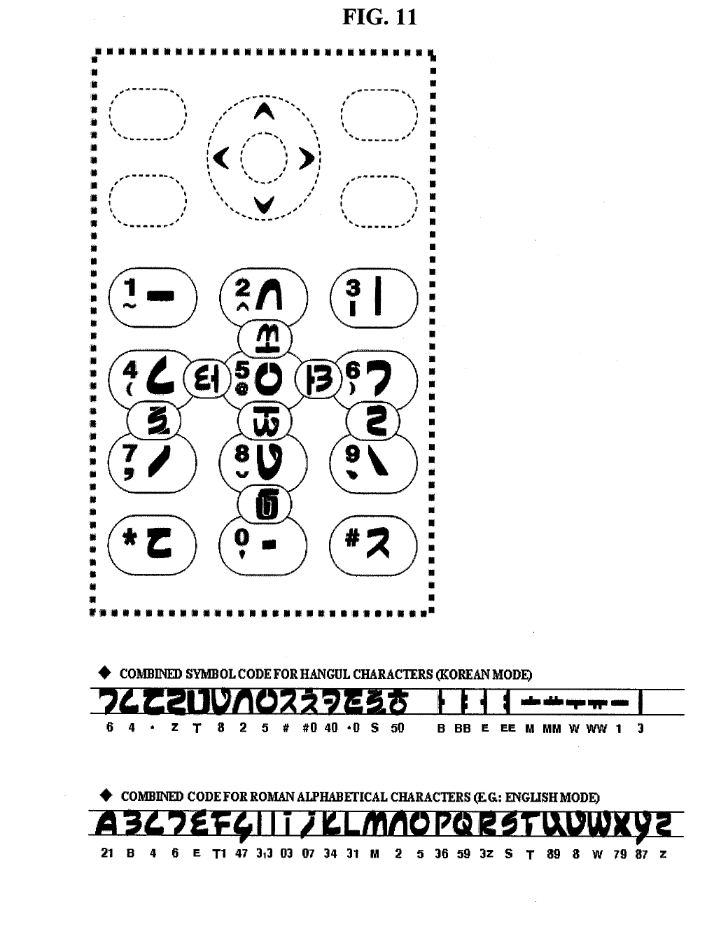

According to an embodiment of the present invention, FIG. 11 illustrates a method of inputting a HANGUL character by allocating symbol characters associated with HANGUL characters to each key button, which are arranged in a form of a 7×5 matrix or a 5×7 matrix, and extracting the allocated symbol characters according to the terminal user's 120 key button input.

FIG. 11 is a diagram illustrating a structure of a terminal keypad, which is utilized for a HANGUL character input method, and a method of inputting a combined symbol character according to a key button input signal, which is included in the terminal according to the present invention.

HANGUL characters consist of 14 consonants and 10 vowels. To indicate HANGUL character, the present inventor selected symbol characters, [symbol] [symbol] [symbol] and [symbol] Also, the symbol characters may be allocated to key buttons of the terminal 110 respectively, based on a usage frequency, character input convenience for the terminal user 120, and the like. Also, as a symbol character input method, when pushing a corresponding key button once, the basic consonant corresponding to the key button is inputted. Also, when pushing a corresponding key button twice, a double consonant corresponding to the key button is inputted. Like the same, when pushing a corresponding key button once, a basic vowel corresponding to the key button is inputted. Also, when pushing a corresponding key button twice, a diphthong corresponding to the key button is inputted.

As an example, referring to FIG. 11, each of the symbol characters, [symbol] [symbol] and [symbol] is allocated to each of independent key buttons 1 to 0, *, and #. Also, each of the symbol characters, [symbol] is allocated to each of twin-tap key buttons, ‘M, W, E, B, S, T, and Z’. In the case of vowels, symbol characters, [symbol] are arranged in all directions according to a direction of ‘-’. Thus, associated vowels may be easily remembered.

In this instance, when the terminal user 120 arbitrarily pushes key buttons, the character input system 200 may extract a symbol character associated with each of the pushed key buttons, and combine the extracted symbol characters into a combined symbol character to correspond to a corresponding HANGUL character (see FIG. 11).

As an example, when the terminal user 120 desires to input a HANGUL character [symbol] the terminal user 120 may input key buttons ‘0 and #’ of the terminal where symbol characters are allocated as illustrated in FIG. 11. In this instance, the character input system 200 may extract symbol character [symbol] and [symbol] associated with the key buttons ‘0 and #’, and combine the same and thereby generate a combined symbol character

[symbol]

Specifically, the terminal user 120 may input a particular HANGUL character by pushing key buttons of symbol characters which are required to constitute the HANGUL character by considering an external shape of the known HANGUL character. Descriptions related to a combination of symbol characters with respect to each Hangul character have been made with reference to FIG. 11, and thus further detailed descriptions will be omitted.

A method of inputting HANGUL characters according to the present invention is performed by the character input system 200 as described above.

The character input system 200 maintains the table 210 which stores a symbol character corresponding to a key button input signal, and a combined symbol character. According to an embodiment of the present invention, as illustrated in FIG. 11, each of the symbol characters, [symbol] [symbol] [symbol] and [symbol] is allocated to each of key buttons of the terminal 110. Also, associated information is stored in the table 210.

Also, the character input system 200 receives at least one key button input signal, which is generated in association with a key button input, from the terminal 110. Next, the character input system 200 extracts at least one symbol character corresponding to the at least one key button input signal from the table 210.

Also, the character input system 200 generates a combined symbol character by combining the extracted at least one symbol character according to a HANGUL character composition principle. In this instance, the generated HANGUL character may include [symbol] [symbol] [symbol] and the like. As illustrated in FIG. 11, each of the combined symbol characters corresponds to each of HANGUL characters which consist of consonants and vowels.

The character input system 200 controls the generated combined symbol character to be displayed on a display of the terminal 110. Also, the character, which is displayed on the display by the character input system 200, may have an external shape of a combined symbol character which is generated by combining symbol characters according to the present invention. According to another embodiment, the character input system 200 may search the table 210 for a printing type HANGUL character which has a comparatively high similarity in the external shape with the generated combined symbol character. The character input system 200 may control the printing type HANGUL character to be displayed on the display. In this instance, the printing type HANGUL character may be easily recognized by a plurality of unspecific persons (HANGUL character users).

Thus, according to the present invention, a combined symbol character corresponding to a desired HANGUL character may be generated by only inputting a stroke (symbol character) which is acquired by disassembling the HANGUL character. Through the operation, a character input rule may be simplified. Also, according to the present invention, since a single symbol character is allocated to each key button for easy input, a symbol character may be more easily inputted.

Thai Character Input

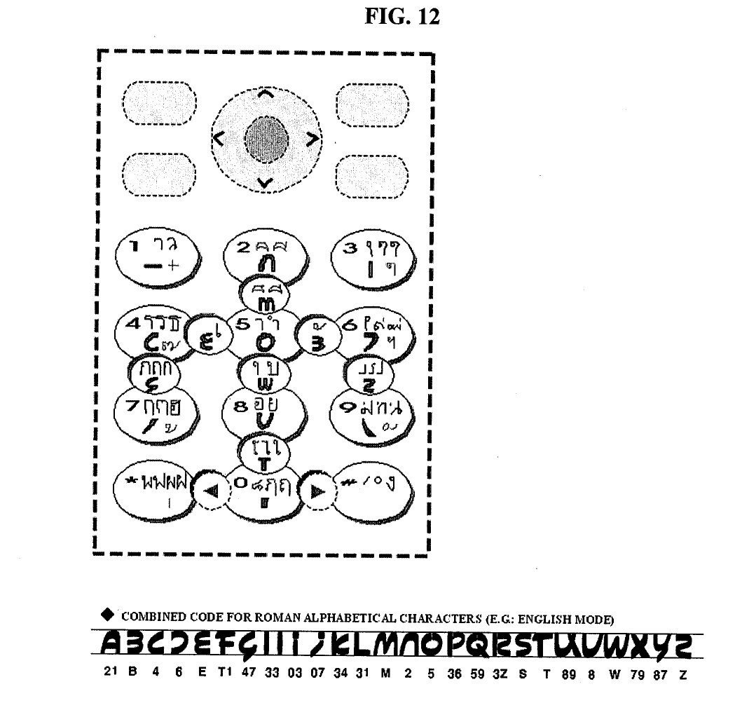

According to another embodiment of the present invention, FIG. 12 illustrates a method of inputting a Thai character by allocating symbol characters associated with Thai characters to each of key buttons, which are arranged in a form of a 7×5 matrix or a 5×7 matrix, and extracting the allocated symbol characters according to the terminal user's 120 key button input.

FIG. 12 is a diagram illustrating a structure of a terminal keypad, which is utilized for a Thai character input method, and a method of inputting a combined symbol character according to a key button input signal, which is included in the terminal according to the present invention.

To express Thai characters, the present inventor selected symbol characters [symbol] [symbol] [symbol] [symbol] [symbol] [symbol] [symbol] and [symbol] Also, the symbol characters may be allocated to key buttons of the terminal 110 respectively, based on the terminal user's 120 recognition and identification, and the like.

Also, a plurality of symbol characters in a similar shape may be associated with a single key button. A symbol character located second may be inputted by pushing a corresponding key button twice and a symbol character located third may be inputted by pushing a corresponding key button three times. Also, four SHENGDIAO marks, sentence marks, and the like, which are allocated to each key button, may be inputted by continuously pushing a corresponding key button.

As an example, referring to FIG. 12, each of the symbol characters, [symbol] [symbol] [symbol] [symbol] [symbol] is allocated to each of independent key buttons 1 to 0, *, and #, respectively. Also, each of the symbol characters, [symbol] [symbol] and [symbol] is allocated to each of twin-tap key buttons, ‘M, W, E, B, S, T, and Z’. Particularly, in the case of Thai characters, since a plurality of symbol characters is associated with each key button, the terminal user 120 may selectively extract a desired character depending upon a number of pushing operations. As an example, when the terminal user 120 pushes the key button ‘2’ once, the symbol character [symbol] may be extracted. When the terminal user 120 pushes the key button ‘2’ twice, the symbol character [symbol] may be extracted.

In this instance, when the terminal user 120 arbitrarily pushes key buttons, the character input system 200 may extract a symbol character associated with each of the pushed key buttons, and combine the extracted symbol characters into a combined symbol character to correspond to a corresponding Thai character (see FIG. 12).

As an example, when the terminal user 120 desires to input a Thai character [symbol] the terminal user 120 may input key buttons ‘6 and 7’ of the terminal 110 where symbol characters are arranged as illustrated in FIG. 12. In this instance, the character input system 200 may extract symbol characters [symbol] and [symbol] associated with the key buttons ‘6 and 7’, and combine the same and thereby generate a combined symbol character

[symbol]

Specifically, the terminal user 120 may input a particular Thai character by pushing key buttons of symbol characters, which are required to constitute the Thai character, by considering an external shape of the known Thai character. Descriptions related to a combination of symbol characters with respect to each Thai character have been made with reference to FIG. 12, and thus further detailed descriptions will be omitted.

A method of inputting Thai characters according to the present invention is performed by the character input system 200 as described above.

The character input system 200 maintains the table 210 which stores a symbol character corresponding to a key button input signal, and a combined symbol character. According to an embodiment of the present invention, as illustrated in FIG. 12, each of the symbol characters, [symbol] [symbol] [symbol] [symbol] [symbol] [symbol] [symbol] and [symbol] is allocated to each key button of the terminal 110. Also, associated information is stored in the table 210.

Also, the character input system 200 receives at least one key button input signal, which is generated in association with a key button input, from the terminal 110. Next, the character input system 200 extracts at least one symbol character corresponding to the at least one key button input signal from the table 210.

Also, the character input system 200 generates a combined symbol character by combining the extracted at least one symbol character according to a Thai character composition principle. In this instance, the generated Thai character may include, [symbol] [symbol] [symbol] [symbol] [symbol] [symbol] [symbol] [symbol] [symbol] and the like. As illustrated in FIG. 12, each of the combined symbol characters corresponds to each respective Thai character.

The character input system 200 controls the generated combined symbol character to be displayed on a display of the terminal 110.

Thus, according to the present invention, a combined symbol character corresponding to a desired Thai character may be generated by only inputting a stroke (symbol character) which is acquired by disassembling the Thai character. Through the operation, a character input rule may be simplified. Also, according to the present invention, since a single symbol character is allocated to each key button for easy input, a symbol character may be more easily inputted.

Particularly, according to the present invention, since symbol characters, which constitute a single combined symbol character, are not affected by subsequently inputted symbol characters, the symbol characters may be inputted without a mistype.

As an example, when the terminal user 120 desires to input Thai characters [symbol] and [symbol] the terminal user 120 may consecutively push key buttons ‘1113167’. In this instance, the character input system 200 may extract symbol characters [symbol] and [symbol] corresponding to the pushing operations. Next, the character input system may combine the extracted symbol characters [symbol] and [symbol] and thereby generate combined symbol characters [symbol] and [symbol] Specifically, the character input system 200 may automatically classify the extracted symbol characters into [symbol] and [symbol] and precisely combine the same into the combined symbol characters [symbol] and [symbol] Since a combined symbol character by, for example, a combination of [symbol] or [symbol] does not exist, the character input system 200 may easily classify the extracted symbol characters [symbol] into [symbol] and

[symbol]

Thus, according to the present invention, a character may be quickly inputted without a mistype in an input system and a waiting input time, and also with a comparatively small number of input strokes.

The multi-language character input method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

### INDUSTRIAL APPLICABILITY

As described above, according to the present invention, there is provided a method of inputting multi-language characters, which can utilize all character input systems based on a keypad system. In this instance, the keypad system overcomes the limit with respect to a keypad size and button arrangement of a small handset terminal. Thus, a character input module according to the present invention may be widely utilized to wired or wirelessly control electric devices, such as a Voice over Internet Protocol (VoIP) wireless terminal, a bi-directional TV remote control, an IP telephone, a PDA keyboard, a number door lock, a wearable PC controller, a KARAOKE device, a game device, an electronic book, a one-hand keyboard for the handicapped, and the like.

Also, according to the present invention, there is provided a method of inputting multi-language characters, which can provide a consistent input rule and convenience with respect to characters of each of every language and Roman alphabetical characters. Thus, the present invention may correspond to a next generation terminal and service where a smart phone, a PDA, a bi-directional TV, a media center PC, a bidirectional DMB device, a telematics device, communications device, and the Internet become convergent.

Also, according to the present invention, there is provided a method and system for inputting multi-language characters using symbol characters, which can reduce a number of pushing operations and thereby reduce a character input time by adopting a character input method according to a combination of symbol characters. In this instance, a number of strokes of a character is considered. Also, the method of inputting multi-language character according to the present invention inputs a symbol character according to a stroke order by using a corresponding character composition principle. Thus, according to the present invention, there is provided a method and system for inputting multi-language character using symbol characters, which can provide a comparatively simple input method when inputting a character on a terminal.

Also, according to the present invention, there is provided a method and system for inputting multi-language character using predictable symbol characters, can predictably arrange symbols and input keys corresponding to a writing stroke order of a character of a corresponding language.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of inputting Roman alphabetical characters via at least one key button of a terminal, the method comprising:
maintaining a keypad which includes the at least one key button disposed with at least one of symbol characters according to each shape of the Roman alphabetical characters, [symbol] [symbol] and [symbol]
maintaining a table which stores a combined symbol character corresponding to an input signal of the key button;
receiving the input signal of the key button from a user;
extracting the combined symbol character corresponding to the input signal of the key button by referring to the table; and
outputting the extracted combined symbol character to a predetermined display.

2. The method of claim 1, wherein the symbol character includes at least one of [symbol] [symbol] [symbol] [symbol] and

[symbol]

3. The method of claim 1, wherein more than 19 key buttons are included in the keypad, and at least one portion of the key buttons is allocated with an input value of a duplicate signal which is generated by simultaneously inputting a first key button pushing signal and a second key button pushing signal.

4. The method of claim 3, wherein the key buttons of the keypad are arranged in a form of any one of a 7×5 matrix and a 5×7 matrix.

5. The method of claim 4, wherein the keypad is configured into a virtual keypad on the display.

6-16. (canceled)

17. A method of inputting Arabic characters via at least one key button of a terminal, the method comprising:
maintaining a keypad which includes the at least one key button disposed with at least one of symbol characters according to each shape of the Arabic characters and Roman Alphabetical characters, [symbol] [symbol] [symbol] (top dot), [symbol] (bottom dot), [symbol] (right dot), [symbol] (Hamza), [symbol] and [symbol]
maintaining a table which stores a combined symbol character corresponding to an input signal of the key button;
receiving the input signal of the key button from a user;
extracting the combined symbol character corresponding to the input signal of the key button by referring to the table; and
outputting the extracted combined symbol character to a predetermined display.

18. The method of claim 17, wherein the combined symbol character includes any one of [symbol] [symbol] [symbol] [symbol] and

[symbol]

19. The method of claim 18, wherein, in the table, the combined symbol character corresponding to the input signal is automatically classified, converted, and inputted as a character which is attached with a vowel mark, or character types of an independent type, a head word type, a middle word type, and a tail word type.

20. The method of claim 17, wherein more than 19 key buttons are included in the keypad, and at least one portion of the key buttons is allocated with an input value of a duplicate signal which is generated by simultaneously inputting a first key button pushing signal and a second key button pushing signal.

21. The method of claim 20, wherein the key buttons of the keypad are arranged in a form of any one of a 7×5 matrix and a 5×7 matrix.

22. The method of claim 21, wherein the keypad is configured into a virtual keypad on the display.

23-61. (canceled)
